(19) United States
(12) Patent Application Publication
(10) Pub. No.: US 2015/0022865 A1
(43) Pub. Date: Jan. 22, 2015

(54) IMAGE PROCESSING APPARATUS

(71) Applicant: CANON KABUSHIKI KAISHA, Tokyo (JP)

(72) Inventor: Yasuyuki Nakamura, Yokohama-shi (JP)

(21) Appl. No.: 14/322,142

(22) Filed: Jul. 2, 2014

(30) Foreign Application Priority Data
Jul. 18, 2013 (JP) 2013-149935

(51) Int. Cl. H04N 1/40; H04N 1/00

(52) U.S. Cl. CPC H04N 1/40093; H04N 1/00408
USPC 358/3.27

(57) ABSTRACT

A control is performed so that only an image processing setting(s) (correction value setting(s)) corresponding to a determination level of blank sheet detection set by the user can be chosen. A control is performed so that image processing correction is set within a correction range of an image processing setting(s) corresponding to a determination level of blank sheet detection set by the user.

### BACKGROUND OF THE INVENTION

1. Field of the Invention

The present invention relates to image processing apparatuses that read an original document to generate image data.

2. Description of the Related Art

A line sensor, such as a charge-coupled device (CCD), a complementary metal-oxide-semiconductor (CMOS), a contact image sensor (CIS), etc., has been conventionally used in a multifunction machine etc. to read an original document. There are two techniques for reading an original document, “flat bed” and “sheet feed.” In the flat-bed technique, a light source and a line sensor are moved at a predetermined speed relative to an original document placed on a glass platen. In the sheet-feed technique, a light source and a line sensor are fixed, and an original document is moved at a predetermined speed. For the sheet-feed technique, in many cases, an automatic document feeder (ADF) is used, which transports original documents to be read, one at a time, to a reading position. When reading is performed using the flat-bed technique, it is clear which side of an original document is to be read, and therefore, if there is no information in an original document image, an attempt to read image data is not performed. However, in the sheet-feed technique, it may not be clear which side of a transported original document is to be read, and therefore, an attempt to read image data may be performed on a wrong side of an original document that does not have printed information when the original document is placed on the ADF with each side thereof facing in the wrong direction. In order to prevent the wrong side of an original document from being read, “blank sheet detection” provided is to determine whether the right side containing printed information is being read using an image processing function while reading the original document. Japanese Patent Laid-Open No. 2008-22276 discloses that when an original document is read, then if it is determined that read image data does not contain printed information, i.e., that the original document is blank, information indicating this situation is sent. This patent document also discloses that, as in the copying operation, when read image data is output, settings for image processing that is performed before outputting image data are sent before the function of detecting a blank sheet is performed, in order to prevent blank image data (blank sheet) from being output.

However, in conventional image forming apparatuses having blank sheet detection, settings for image processing following blank sheet detection are only sent before blank sheet detection is performed, and it is the user of the image forming apparatus that determines setting for image processing that cause final blank image data (blank sheet) not to be output. Therefore, the user of the image forming apparatus may not obtain the effect of preventing an output of a blank sheet, although blank sheet detection is used in reading of an original document. For example, while the density of an image in an original document may be thin, and it may be determined by blank sheet detection function that the original document is not blank, substantially all the image may be lost due to image processing, etc. The user who operates the image forming apparatus needs to provide settings for image processing following blank sheet detection again in order to avoid outputting a blank sheet. In order to prevent a blank image (blank sheet) from being finally output, settings are provided after knowing what kind of image processing is involved. If a plurality of kinds of image processing are involved, a combination of the settings needs to be considered. Moreover, if level settings for detecting a blank sheet are provided for blank sheet detection function, there may be a case where even when blank sheet detection is set so that it is unlikely to determine that an original document is blank, the final output image may be blank, i.e., a blank image (blank sheet) may be finally output, due to image processing following blank sheet detection. Moreover, if blank sheet detection function is performed immediately before printing or outputting image data in order to prevent a blank image (blank sheet) from being finally output, blank sheet detection cannot be performed when a function that does not involve printing (the function of transmitting to a communication network external to the image forming apparatus, etc.), which is a problem.

### SUMMARY OF THE INVENTION

The present invention provides a solution to the above problems. According to the present invention, a difference between a detection level of blank sheet detection of a read original document image and a correction level for an output image is reduced or eliminated.

According to one aspect of the present invention, there is provided an image processing apparatus comprising: a first setting unit that sets a first setting value used to determine whether or not an obtained original document is blank; a second setting unit that sets a second setting value used to correct a component relating to a lightness of image data obtained by reading the original document; a detection unit that determines whether or not an original document to be processed is blank, based on the first setting value set by the first setting unit; and a processing unit that corrects the lightness of image data obtained by reading an original document that has been determined by the detection unit not to represent a blank sheet, based on the second setting value set by the second setting unit, wherein the setting range of the first or second setting value set by one of the first and second setting units is limited by the first or second setting value set by the other setting unit.

According to another aspect of the present invention, there is provided an image processing apparatus comprising: a setting unit for choosing, from a plurality of setting values, a setting value that is used in determining whether or not an obtained original document is blank; a detection unit for determining whether or not an original document to be processed is blank for the plurality of setting values; and a storage unit for storing results of the determination by the detection unit using the plurality of setting values in association with the corresponding one of the plurality of setting values, and the setting value chosen by the setting unit.

According to the present invention, a setting level of blank sheet detection for determining whether or not read image data represents a blank sheet, and a correction level of image processing performed on the image data on which blank sheet detection has been performed, can be correlated with each other. In an embodiment in which the choice of a correction level of image processing is limited with respect to the operation unit of the image forming apparatus, erroneous setting by the user that may lead to an inappropriate operation of the apparatus can be reduced or prevented. In an embodiment in which a parameter of image processing to be performed is set again within a setting range corresponding to a setting level of blank sheet detection, the setting level of blank sheet detection and the correction level of image processing can be correlated with each other without the user's knowledge. Therefore, as a result of image processing performed on image data that has been determined not to represent a blank sheet as a result of blank sheet detection, the outputting of the image data as a blank sheet can be reduced or prevented.

Further features of the present invention will become apparent from the following description of exemplary embodiments with reference to the attached drawings.

### BRIEF DESCRIPTION OF THE DRAWINGS

FIG. 1 is a diagram showing a configuration of the present invention.

FIG. 2 is a diagram showing an internal configuration of an image input unit.

FIG. 3 is a diagram showing an internal configuration of an image processing unit.

FIGS. 4A, 4B, 4C, and 4D are diagrams showing example displays of an operation unit that is used to choose an operation of an apparatus of the present invention.

FIGS. 5A, 5B, 5C, and 5D are diagrams showing example displays of an operation unit in a first embodiment.

FIGS. 6A, 6B, 6C, and 6D are diagrams showing example displays of the operation unit in the first embodiment.

FIGS. 7A, 7B, 7C, and 7D are diagrams showing example displays of the operation unit in the first embodiment.

FIGS. 8A, 8B, 8C, and 8D are diagrams showing example displays of the operation unit in the first embodiment.

FIG. 9 is a diagram showing a control flow in the first embodiment.

FIGS. 10A, 10B, and 10C are diagrams for describing blank sheet detection.

FIGS. 11A, 11B, 11C, and 11D are diagrams showing example displays of an operation unit in a second embodiment.

FIG. 12 is a diagram showing a control flow in the second embodiment.

FIG. 13 is a diagram showing a storage configuration of a storage unit in a third embodiment.

FIG. 14 is a diagram showing a control flow in the third embodiment.

FIGS. 15A and 15B are diagrams showing a relationship between blank sheet detection settings and correction settings in a fourth embodiment.

FIG. 16 is a diagram showing a control flow in the fourth embodiment.

FIG. 17 is a diagram showing a control flow in the fourth embodiment.

FIG. 18 is a diagram showing a control flow in the fourth embodiment.

FIG. 19 is a diagram showing an internal configuration of an image processing unit in a fifth embodiment.

FIG. 20 is a diagram showing a configuration of an operation unit in a sixth embodiment.

### DESCRIPTION OF THE EMBODIMENTS

### First Embodiment

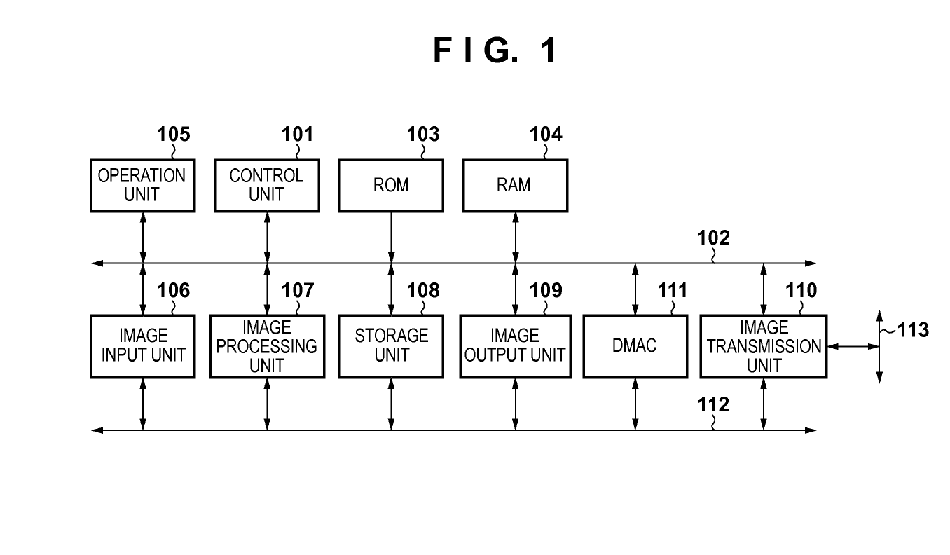

Embodiments of the present invention will now be described with reference to the accompanying drawings. FIG. 1 is a diagram showing an embodiment of the present invention. In FIG. 1, a control unit 101 controls the entire apparatus, and includes a CPU (Central Processing Unit) etc. A control bus 102 connects the CPU 101 and each block together. A ROM (Read Only Memory) 103 stores a program executed by the CPU 101. A RAM (Random Access Memory) 104 is used as a temporary storage or work memory for storing control data under the control of the CPU 101. An operation unit 105 includes a display apparatus such as a liquid crystal panel (LCD: Liquid Crystal Display) etc., and a pointing apparatus such as a touchpad etc., and is, for example, used by the user to instruct the apparatus to perform an operation etc. An image input unit 106 reads image data of an original document. An image processing unit 107 performs image processing on image data read by the image input unit 106. A storage unit 108 stores input/output data of the image input unit 106 or the image processing unit 107, and includes a hard disk drive (HDD), a solid-state drive (SSD), a DDR-SDRAM (Double Data Rate Synchronous Dynamic Random-Access Memory), etc. An image output unit 109 prints or outputs image data processed by the image processing unit 107. An image transmission unit 110 transmits image data of an original document read by the image input unit 106, image data processed by the image processing unit 107, or image data stored in the storage unit 108. A DMAC (Direct Memory Access Controller) 111 performs data transfer control between the image input unit 106, the image processing unit 107, the storage unit 108, the image output unit 109, and the image transmission unit 110 under the control of the control unit 101. A data bus 112 is used in data transfer performed by the DMAC 111. A communication network 113 is a communication network (LAN: Local Area Network, etc.) that is external to the apparatus and is connected to the image transmission unit 110.

<Configuration of Image Input Unit 106>

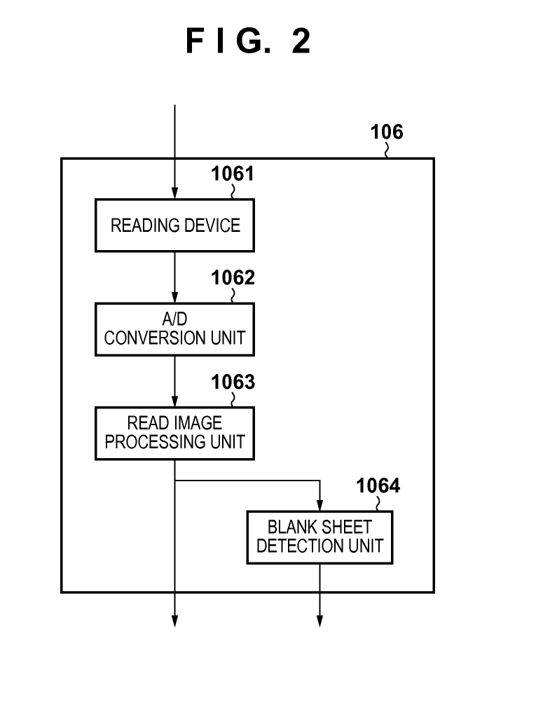

A configuration of the image input unit 106 will be described with reference to FIG. 2. FIG. 2 is a diagram showing an internal configuration of the image input unit 106. In FIG. 2, a reading device 1061 includes a CCD, a CMOS, or a CIS. Image data of an original document is read via the reading device 1061, and the analog read image data is output to a processing unit following the reading device 1061. An A/D conversion unit 1062 converts data read by the reading device 1061 into digital data. A read image processing unit 1063 performs processes, such as shading correction in which the levels of a highlight portion (white) and a dark portion (black) of read image data are corrected, MTF (Modulation Transfer Function) correction, high-frequency suppression, etc. A blank sheet detection unit 1064 checks image data processed by the read image processing unit 1063 to determine whether or not read image data represents a blank sheet.

<Method for Detecting Blank Sheet>

As used herein, the term “blank sheet” refers to an original document that is determined to have substantially no printed information (i.e., contents). A colored original document such as colored paper, and recycled paper, are also handled as a blank sheet if it contains substantially no printed information. In other words, to determine whether or not an original document is blank is to determine whether or not there are contents printed on an original document. Image data obtained when an original document having substantially no printed information is read, and image data that comes from an image on the opposite side of paper, are also considered to represent a blank sheet. On the other hand, an original document having a small amount of characters or low-density halftone printed characters is not blank.

A technique for detecting a blank sheet using the blank sheet detection unit 1064 employs, for example, a frequency distribution of image data processed by the read image processing unit 1063. The blank sheet detection unit 1064 generates a frequency distribution of image data read from a sheet of original document based on the image data output by the read image processing unit 1063. Thereafter, an average value and a variance value are calculated from the generated frequency distribution. The reason for the calculation of the variance value is that a feature is utilized that when image data read from an original document contains significant information (i.e., the original document is not blank), the calculated variance value is large.

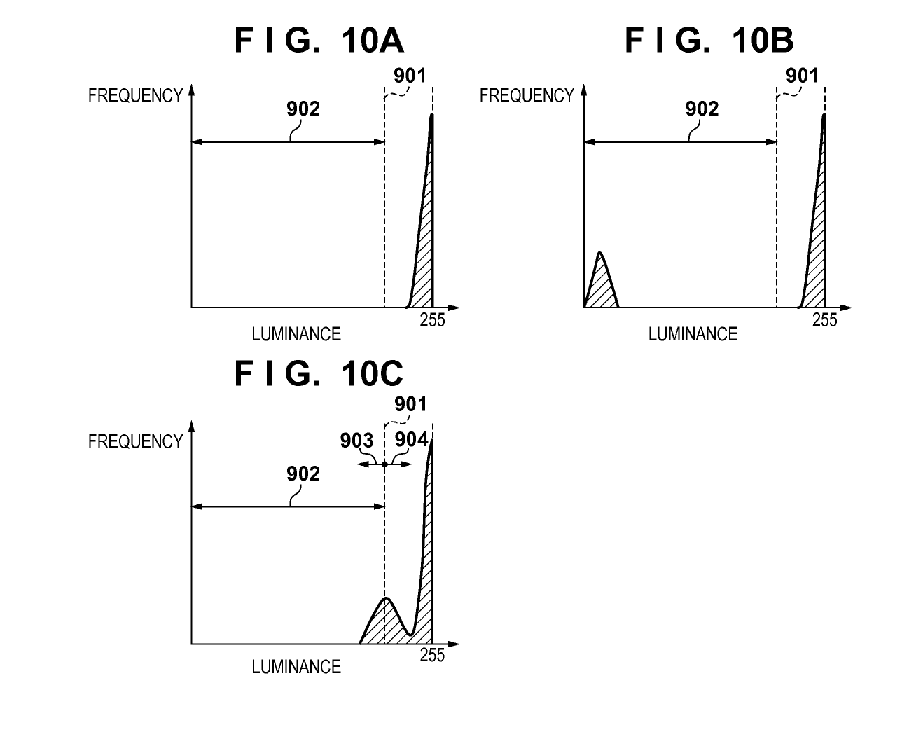

A frequency distribution representing a blank sheet and a frequency distribution containing information will be described with reference to FIGS. 10A-10C. In FIGS. 10A-10C, the horizontal axis represents pixel values where input image data has an 8-bit value (value range: 0-255), and the vertical axis represents the frequencies of the pixel values (the frequency here means the number of pixels having a certain pixel value). In the description that follows, image data read by the reading device 1061 is assumed to be luminance information, and it is also assumed that data closer to white has a larger numerical value and data closer to black has a smaller numerical value. If image data read from an original document represents a blank sheet, read pixel data has a large numerical value (luminance information). Therefore, the frequency distribution of a blank sheet has a shape in which high frequencies are concentrated at high luminances as shown in FIG. 10A. In FIG. 10A, if a threshold 901 is defined as a threshold that is used in determination of whether or not image data read from an original document indicates “white,” the total number of pixels that has a luminance greater than or equal to the threshold 901 may be used as information indicating “white.” The number of pixels falling within a luminance range 902, i.e., the total number of pixels having a luminance falling below the threshold 901 may be used as information other than “white.” If read image data contains some contents such as characters etc., as shown in FIG. 10B there is a distribution of pixels indicating information other than “white,” in the range 902 falling below the threshold 901. When the frequency distribution has such a shape, the calculated variance value is large. Therefore, if the average value and the variance value are calculated from the frequency distribution, it can be determined whether or not the image to be determined is blank. The reason for the calculation of the variance value for determining whether or not an original document is blank is that when an original document is a blank sheet that does not contain contents, then even if the document is, for example, colored, the original document has a uniform density, and therefore, there is a significant number of pixels having a certain density (i.e., a read luminance), and the variance of the pixel values is considerably small, and therefore, if the variance falls below the threshold, it may be determined that the original document is blank. Note that original document image data to be read may be divided into a plurality of regions, a frequency distribution and a variance value may be calculated for each region, and it may be determined that the entire original document is blank if all of the regions have been determined to be blank, whereby it can be determined whether or not an original document is blank, taking variations in each region into consideration. Also, in this embodiment, a frequency distribution, and a variance value calculated from the frequency distribution, are used by the blank sheet detection unit 1064 to determine whether or not an original document is blank, the blank sheet detection unit 1064 of this embodiment is not limited to this technique. Specifically, a processing unit for detecting an edge from read image data may be provided, the number of pixels that have been determined to form an edge is counted, and based on the count value, it may be determined whether or not an original document is blank. Alternatively, a combination of a frequency distribution, a variance value, and the number of edges may be used to determine whether or not an original document is blank.

When blank sheet detection is performed using such a technique, the image forming apparatus can set a level (setting value) for determining that an original document is blank. For example, if there is a frequency distribution shown in FIG. 10C, the range 902 has some pixels falling therein, and therefore, the image data is unlikely to be determined to represent a blank sheet. However, if the setting value is changed to change the threshold 901 in a direction 903, i.e., the luminance that is the threshold is decreased, the range 902 is narrowed, so that the number of pixels exceeding the threshold 901 increases. As a result, the calculated variance value decreases, so that the image data is more likely to be determined to represent a blank sheet. On the other hand, if the setting value is changed to change the threshold 901 in a direction 904, i.e., the lightness that is the threshold is increased, the range 902 is broadened, so that the number of pixels exceeding the threshold 901 decreases. As a result, the calculated variance value increases, so that image data is less likely to be determined to represent a blank sheet. Thus, if the value of the threshold 901 is changed, the criterion for determining whether or not an original document is blank can be changed. Specifically, when it is not desirable to determine that an original document that contains a large amount of low-density characters or image data is blank, the level of determining whether or not an original document is blank (blank page determination level) may be set so that it is less likely to determine that an original document is blank (lower blank page determination level: direction 904).

Conversely, when it is desirable to determine that a low-density original document is blank, the blank page determination level may be set so that it is more likely to determine that an original document is blank (higher blank page determination level: direction 903). In the description that follows, it is assumed that the blank sheet detection unit 1064 is configured to be able to set the blank page determination level. Specifically, as the blank page determination level is lower, it is less likely to determine that an original document is blank. Conversely, as the blank page determination level is higher, it is more likely to determine that an original document is blank.

The image input unit 106 outputs image data that has been obtained by the read image processing unit 1063 processing read original document image data, and the result of blank page determination by the blank sheet detection unit 1064. When blank page determination is performed using a frequency distribution, a variance value calculated from the frequency distribution, etc., the blank page determination may be performed a plurality of times using a plurality of determination levels, whereas the image input unit 106 performs reading of an original document once. Specifically, a plurality of thresholds having different determination levels may be applied to the calculated variance to obtain the result of blank page determination for each threshold. Therefore, it is not necessary to read the same original document for each blank page determination level, i.e., it is not necessary to read the same original document a plurality of times.

Note that the blank page determination result output by the blank sheet detection unit 1064 may be limited only to that which is based on the blank sheet detection level set by the user of the image forming apparatus used in this embodiment. Alternatively, the blank page determination results based on all blank sheet detection levels to which the image forming apparatus used in this embodiment can be set may be output. When only the blank page determination result based on the blank sheet detection level set by the user of the image forming apparatus of this embodiment is output, a value of “1” is output if it is determined that image data to be processed represents a blank sheet, and a value of “0” is output if it is determined that image data to be processed does not represent a blank sheet. Also, when there are five blank sheet detection levels to which the image forming apparatus used in this embodiment can be set, the five blank sheet detection results may be represented by a single value (e.g., “00111”) where a more significant bit indicates the result obtained using a weaker blank sheet detection power, i.e., a lower blank sheet detection level for which an original document is less likely to be determined to be blank, whereby clearly indicating which blank sheet detection level has been used to perform the determination during reading of an original document. For example, when the blank sheet detection results are represented by “00111” whose order of the digits is defined above, then if the set blank sheet detection power is one for which an original document is the second most likely to be determined to be blank (i.e., the second highest determination power or determination level), information indicating that “the set blank sheet detection power is the second highest” can be referenced together with the blank sheet detection result.

The output data of the image input unit 106 and the blank sheet detection result are transferred to the storage unit 108 by the DMAC 111 under the control of the control unit 101. The storage unit 108 temporarily stores the image data and the blank sheet detection result transferred via the DMAC 111. The image data stored in the storage unit 108 is transferred to the image processing unit 107 by the DMAC 111 under the control of the control unit 101.

<Internal Configuration of Image Processing Unit 107>

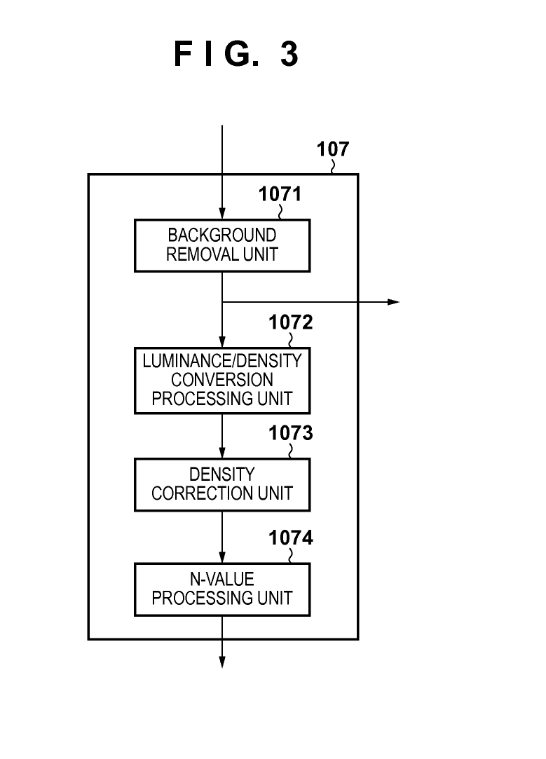

FIG. 3 shows an internal configuration of the image processing unit 107. In FIG. 3, a background removal unit 1071 removes a background (paper's own color) of an original document from pixel data input to the image processing unit 107. There are following classes of background of an original document: achromatic background (the component luminance values R, G, and B obtained during color reading are substantially equal to each other); and chromatic background as used in newspaper (the component luminance values R, G, and B obtained during color reading are different from each other). Therefore, the background removal process by the background removal unit 1071 requires the luminance values of background, and therefore, may often be performed based on the frequency distribution of each component luminance value read by the image input unit 106. Specifically, in the background removal process, a most frequent luminance value of each component is determined to be the luminance value of the background based on the obtained or generated frequency distribution, and a correction process is performed so that the luminance value is set as the luminance value of highlight (white). For example, when the most frequent luminance value is 220 where the gradation is expressed in 8-bits (0-255), a gain value that causes this “220” to represent highlight (white: 255) is calculated. Specifically, the gain value in this case is calculated by:

255/220≈1.16 (1)

By performing a process of multiplying the output image data of the image input unit 106 by the calculated gain value, all pixel values that have a luminance value larger than or equal to the luminance value of background become highlight (white) image data, whereby the background can be removed. Note that the gain value calculation and multiplication processes are performed on all components that are read by the image input unit 106. Therefore, a specific gain value is determined for each component. Although, in Expression 1, the gain value is calculated, assuming that the highlight (white) value is the highest luminance value, the present invention is not limited to this value. Alternatively, instead of using the highest luminance value as the target for calculation of the gain value, a slightly lower value may be used as the target for calculation of the gain value. Also, in the determination of the background lightness value, instead of using the most frequent luminance value of each component, frequencies having those around the most frequent luminance value may be referenced for the calculation. Note that, in the background removal process by the background removal unit 1071, a power for removing background may be set based on a setting of the operation unit 105. The setting of the power in this case corresponds to, for example, the operation of the gain value. In order to decrease the power for removing background, the gain value calculated according to Expression 1 is decreased. When the gain value is decreased, then even if the pixel data output by the image input unit 106 is multiplied by the gain value, the resultant value does not reach the upper limit of the bit value of pixel data, so that the proportion of white pixels in the image data decreases, and therefore, the power for removing background decreases. Also, when the target luminance value for the gain value calculation is not the upper limit of the bit value of input pixel data, the power for removing background can be enhanced. This may be achieved by increasing the gain value calculated according to Expression 1. When the pixel data output by the image input unit 106 is multiplied by the increased gain value, the pixel data output by the image input unit 106 is closer to the upper limit of the bit value, so that the power for removing background is enhanced.

Therefore, by associating the gain value operation with a setting of the operation unit 105, the user of the apparatus can change the power for removing background. Although it is assumed above that the background removal process is performed by multiplying the gain value and the process result of the image input unit 106, another process or configuration may be employed. For example, an LUT (Look Up Table) may be used for the process. Correction table values corresponding to the power of the background removal process by the operation unit 105 may be set in the LUT to implement the correction process of removing background from the output result of the image input unit 106. When the operation of the image forming apparatus of this embodiment is transmission of read image data read by the image input unit 106 via the image transmission unit 110, the image processing unit 107 outputs the result of the process by the background removal unit 1071. Specifically, image data that is the result of the process of the background removal unit 1071 is transferred to the storage unit 108 via the DMAC 111 under the control of the control unit 101. Image data that is the process result of the background removal unit 1071 stored in the storage unit 108 is transferred to the image transmission unit 110 via the DMAC 111 under the control of the control unit 101. The image transmission unit 110 sequentially outputs the image data transferred by the DMAC 111 to the communication network 113, thereby transmitting the read image data.

When the operation of the image forming apparatus used in this embodiment is printing or outputting of read image data, the image processing unit 107 converts the luminance image data output by the background removal unit 1071 into density image data using a luminance/density conversion processing unit 1072. Density correction is performed by a density correction unit 1073 on the density image data output by the luminance/density conversion processing unit 1072. The process of the density correction unit 1073 is to adjust the density of the subsequent printed or output matter. In many cases, the adjustment value may be set based on a setting of the operation unit 105. For example, when a setting for increasing the density has been made in the operation unit 105, the value of image data input to the density correction unit 1073 is adjusted to be closer to the dark portion (black), resulting in output image data that represents printed matter whose density is globally increased. When a setting for decreasing the density has been made in the operation unit 105, the value of image data input to the density correction unit 1073 is adjust to be closer to the highlight portion (white), resulting in output image data that represents printed matter whose density is globally decreased.

The image data adjusted by the density correction unit 1073 is converted by an N-value processing unit 1074 into values that can be used in printing or outputting. The image processing unit 107 outputs N-value image data generated by the N-value processing unit 1074. The DMAC 111 transfers the output image data of the image processing unit 107 to the storage unit 108 under the control of the control unit 101. Thereafter, the output image data of the image output unit 107 stored in the storage unit 108 is transferred to the image output unit 109 by the DMAC 111 under the control of the control unit 101. The image output unit 109 prints or outputs the output image data of the image processing unit 107 stored in the storage unit 108. Note that the form of the output apparatus of the image output unit 109 may be an electrophotographic output apparatus or an inkjet output apparatus, and the present invention is not limited to this.

This embodiment has, as a feature, a correlation between settings of the blank sheet detection level of the blank sheet detection unit 1064, the background removal level of the background removal unit 1071, and the density correction level of the density correction unit 1073 described above. A case where the operation of the image forming apparatus used in this embodiment is transmission operation to the communication network 113 by the image transmission unit 110 will now be described in detail.

<Example Display of Operation Unit>

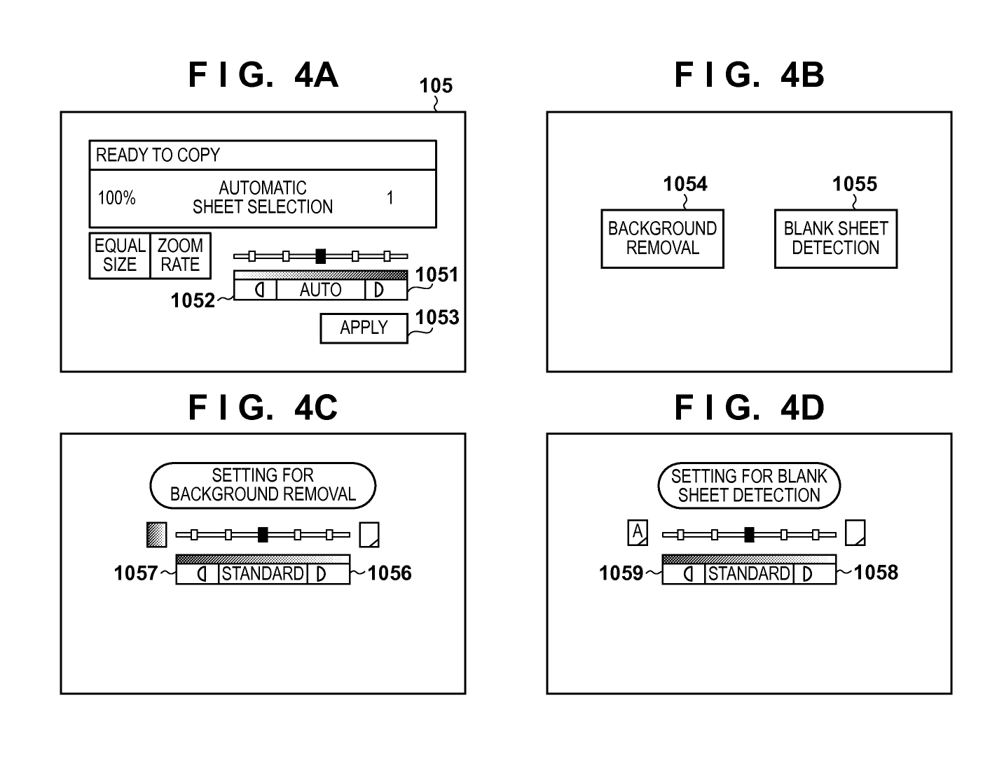

FIGS. 4A, 4B, 4C, and 4D show example displays of a user interface in the operation unit 105 of the image forming apparatus used in this embodiment. FIG. 4A shows an initial screen of the operation unit 105, indicating a state of the apparatus, a setting for magnification, a setting for density adjustment, and an operation mode setting for choosing an operation mode other than copying. In FIG. 4A, a setting key 1051 is pressed down to change a setting of the density correction unit 1073 so that the density is gradually increased, and a setting key 1052 is pressed down to change a setting of the density correction unit 1073 so that the density is gradually decreased. A setting key 1053 is pressed down to choose an operation of the image forming apparatus used in this embodiment. In order to cause the image forming apparatus used in this embodiment to perform transmission operation, the operation unit 105 is used to choose transmission operation as the operation mode setting. Thereafter, when transmission operation is performed, then if the user desires to change a setting for image processing, the user presses down the setting key 1053 of the operation unit 105. The control unit 101, when detecting pressing down of the setting key 1053 of the operation unit 105, changes the display of the operation unit 105 to that shown in FIG. 4B.

In FIG. 4B, a background removal level setting key 1054 is pressed down to set the background removal level of the background removal unit 1071. The background removal level setting key 1054 is pressed down to set a degree (level) by which the background of an original document approaches highlight (white). Based on this setting, the gain value that is used in background removal is determined.

When the display of the operation unit 105 is in the state shown in FIG. 4B, then if the setting key 1054 is pressed down, the control unit 101 changes the display of the operation unit 105 to that shown in FIG. 4C. FIG. 4C shows a second setting unit for setting a performance level of the background removal process performed by the background removal unit 1071. In FIG. 4C, a setting key 1056 is pressed down to increase the background removal level, i.e., to enhance a level by which image data approaches highlight (white). Specifically, the gain value that is used in background removal is increased.

On the other hand, a setting key 1057 is pressed down to decrease the background removal level, i.e., to weaken a level by which image data approaches highlight (white). Specifically, the gain value that is used in background removal is decreased.

In FIG. 4C, as the setting is moved further to the right (the gain value is increased), image data is more likely to be white. Although it is herein assumed that there are five setting levels to which the background removal unit 1071 can be set, the present invention is not limited to this. Specifically, the number of levels to which the background removal unit 1071 can be set may be three, seven, etc. The gain value that is used in the background removal process may be set in association with the level (second setting value).

When the display of the operation unit 105 is in the state shown in FIG. 4B, then if the blank sheet detection level setting key 1055 is pressed down, the control unit 101 changes the display of the operation unit 105 to that shown in FIG. 4D. FIG. 4D shows a first setting unit that is used to set a determination level (first setting value) for blank sheet detection performed by the blank sheet detection unit 1064. In FIG. 4D, a setting key 1058 is pressed down to increase the determination level of blank sheet detection, i.e., to provide a setting for causing an original document to be more likely to be determined to be blank. A setting key 1059 is pressed down to decrease the determination level of blank sheet detection, i.e., to provide a setting for causing an original document to be less likely to be determined to be blank. For example, this setting moves the threshold 901 of FIGS. 10A-10C rightward (the luminance value that is the threshold increases). In FIG. 4D, as the setting is moved further to the right, an original document is more likely to be determined to be blank. Although it is herein assumed that there are five setting levels to which the blank sheet detection unit 1064 can be set, the number of levels to which the blank sheet detection unit 1064 can be set is not limited to five. Specifically, as with the setting of the background removal unit 1071, the number of levels to which the blank sheet detection unit 1064 can be set may, for example, be three, seven, etc. The threshold that is used in blank sheet detection is set in association with the level (first setting value).

<Operation of Image Forming Apparatus>

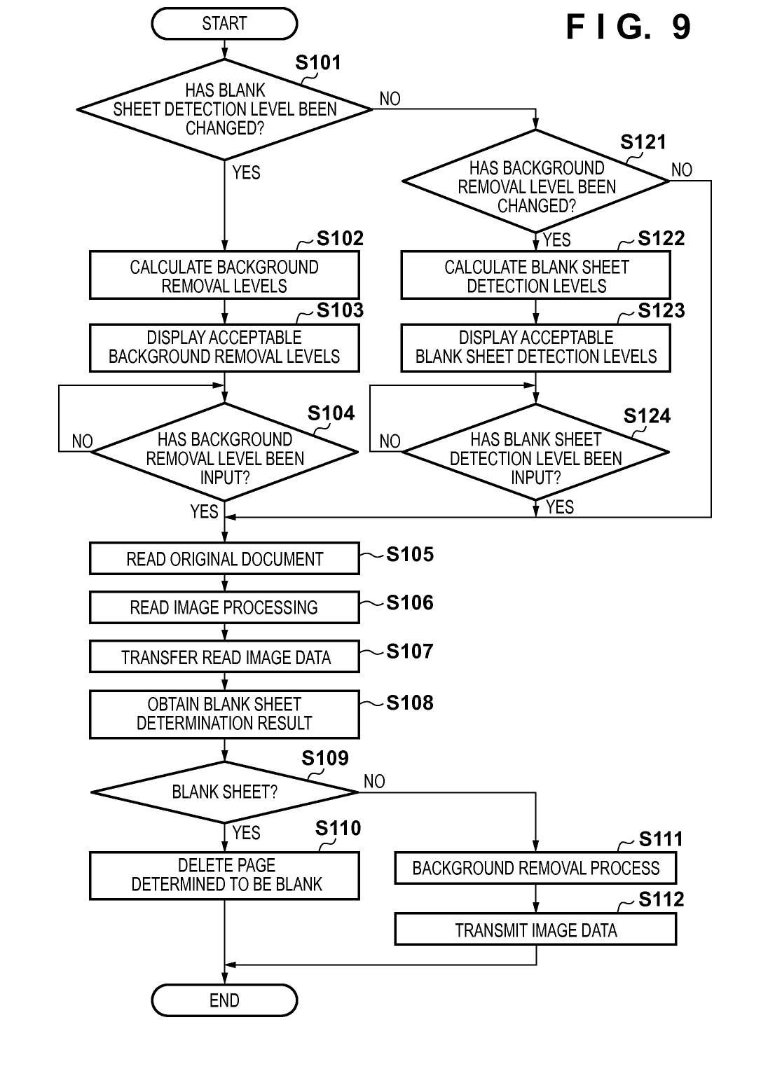

An operation of a processing unit included in the image forming apparatus used in this embodiment, and the display of the operation unit 105, which are most characteristic portions of the present invention, will now be described. FIG. 9 is a control flow of an operation of the image forming apparatus used in this embodiment that is performed when the image transmission unit 110 transmits image data of a page to be processed to the communication network 113 (note that it is assumed that steps described in the flow below are stored in a storage device that is any of the ROM, RAM, and storage unit of FIG. 1, and executed by a CPU (not shown) of the control unit 101).

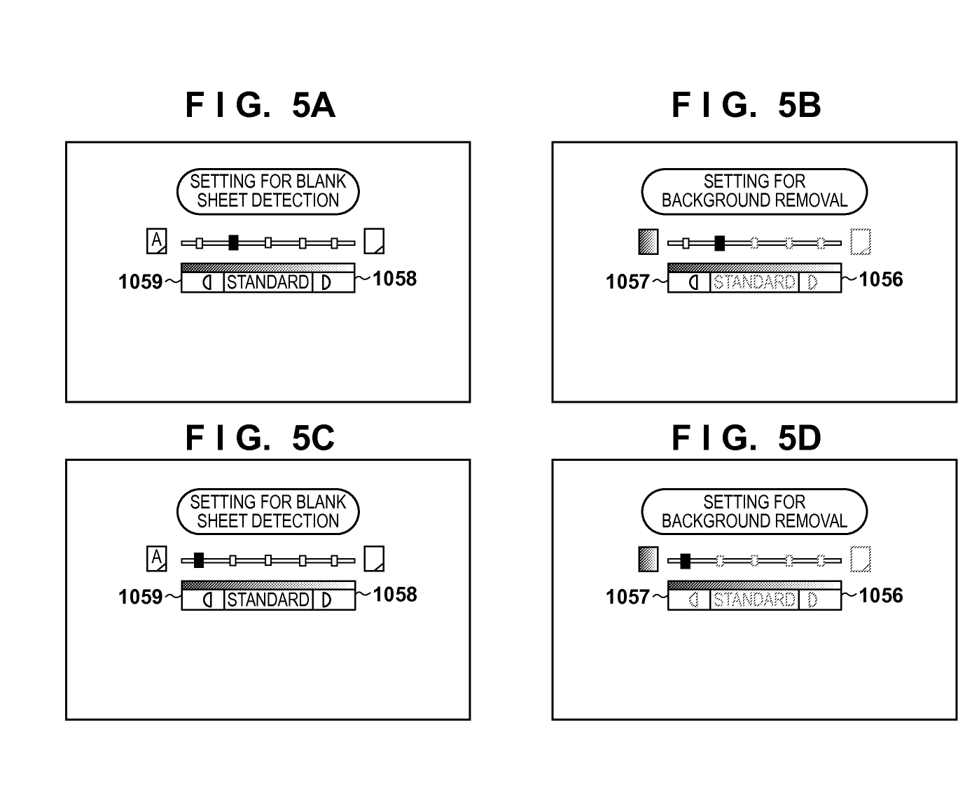

When the user chooses transmission operation as a setting of the operation unit 105, the control unit 101 reads the setting level of blank sheet detection for transmission operation, from a storage area that stores setting values, using the operation unit 105. The control unit 101, when determining that the setting level of blank sheet detection set by the operation unit 105 has been changed from a predetermined initial value (middle value), goes to a control corresponding to the situation that the setting level of blank sheet detection has been changed (YES in step S101). The control unit 101 obtains an acceptable level(s) of the background removal unit 1071 corresponding to the setting level of blank sheet detection (step S102). Thereafter, the control unit 101 changes the display of the obtained background removal level(s) to which the background removal unit 1071 cannot be set to a state in which these levels cannot be chosen (step S103). When the setting level of blank sheet detection in the operation unit 105 is, for example, set to a level that is immediately lower than the standard level (middle), i.e., a level that causes an original document to be less likely to be determined to be blank, by pressing down the setting key 1059 as shown in FIG. 5A, the two highest ones of the levels to which the background removal unit 1071 can be set can be chosen as shown in FIG. 5B, and only the acceptable levels are displayed in a form that allows the user to choice them. Note that when the current setting level of background removal is unacceptable, the setting level of background removal is changed to a level that is closest to the current setting level and falls within the acceptable range. FIG. 5B shows an example display of such a case. The blank sheet detection unit 1064 has been set to a level that is immediately lower than the standard level (middle), i.e., a level that causes an original document to be less likely to be determined to be blank. Therefore, if the background removal unit 1071 removes the background using a higher power (smaller gain value), image data that has been determined by the blank sheet detection unit 1064 not to represent a blank sheet may be caused to represent a blank sheet due to the correction performed by the background removal unit 1071. During transmission operation, image data that has been determined by the blank sheet detection unit 1064 to represent a blank sheet is not transmitted via the image transmission unit 110. However, image data that has been determined by the blank sheet detection unit 1064 not to represent a blank sheet is output by the DMAC 111 to the image transmission unit 110 via the storage unit 108 and the image processing unit 107. The image processing unit 107 performs the background removal process based on the setting for background removal, and therefore, image data that to be transferred to the image transmission unit 110 may be corrected to represent a blank sheet as a result of the process of the background removal unit 1071. Specifically, image data that has been determined not to represent a blank sheet may be corrected to represent a blank sheet due to the correction performed by the background removal unit 1071, and then output from the image transmission unit 110 to the communication network 113. In this case, image data that has been determined not to represent a blank sheet is corrected to represent a blank sheet and is then output to the communication network 113. Therefore, not only this operation is not intended by the user, but also image data that is different from correct one that should be transmitted is output.

Therefore, when the blank sheet detection level increases and therefore an original document is more likely to be determined to be blank as described above, the background removal level is proportionately increased to increase the gain value that is used in background removal. In other words, the lightness of image data can be changed to be closer to highlight.

Conversely, when the blank sheet detection level is decreased and therefore an original document is less likely to be determined to be blank, image data containing lower-density contents is determined not to represent a blank sheet, and therefore, the background removal level needs to be proportionately decreased to decrease the gain value that is used in background removal. In one technique, a correlation between the levels may be previously determined. In this case, for example, when the level of blank sheet detection is changed to the next lower level, the acceptable level of background removal is also changed to the next lower level. Note that a parameter for each level is previously determined, and processes such as blank sheet detection and background removal are performed using the parameters for chosen levels. Appropriate parameters may be empirically determined, for example.

Therefore, the control unit 101 of the image forming apparatus used in this embodiment controls, during transmission operation, the blank sheet detection unit 1064 and the background removal unit 1071 so that the blank page determination process and the background removal process thereof appropriately function. Specifically, the control unit 101 limits the range within which the background removal unit 1071 can be set (the range may also be hereinafter referred to as an “acceptable range”), based on the setting level of blank sheet detection of the blank sheet detection unit 1064. Specifically, the acceptable level(s) of the background removal unit 1071 corresponding to the setting level of the blank sheet detection unit 1064 is obtained, and based on the result, only a setting level(s) at which the background removal unit 1071 can perform the process can be chosen. FIG. 5B shows this situation, i.e., the setting key 1056 for determining the setting of the background removal unit 1071 is displayed in a form (in a gray color) that indicates that a setting for increasing the effect of the background removal process of the background removal unit 1071 (providing highlight) cannot be chosen. In other words, the display indicates that the gain value used in the background removal process cannot be decreased.

Moreover, FIG. 5C shows a situation that the blank page determination level of the blank sheet detection unit 1064 is set to be two levels lower than the standard level so that an original document is less likely to be determined to be blank. FIG. 5D shows levels to which the background removal unit 1071 can be set in this situation. Because the setting level of the blank page determination of the blank sheet detection unit 1064 is set to a level at which an original document is least likely to be determined to be blank, the control unit 101 also limits the setting level of background removal based on that level. Specifically, the control unit 101 performs a control so that only a setting(s) that causes a reduced effect of the background removal process (i.e., the correction process of the background removal unit 1071) can be chosen. Specifically, in the case of the setting level of blank sheet detection of FIG. 5C, the control unit 101 displays the setting key 1056 in a form (in a gray color) that indicates that the setting key 1056 cannot be pressed down as shown in FIG. 5D. Specifically, the display indicates that the threshold used in the background removal process cannot be further decreased.

In FIGS. 5A-5D, the blank page determination level of the blank sheet detection unit 1064 has been set to be immediately lower than the standard level (middle value), i.e., image data is less likely to be determined to represent a blank sheet. Therefore, the control unit 101 limits the setting level of the background removal unit 1071 so that the background is less likely to be removed. However, the correlation between the setting level of the blank sheet detection unit 1064 and the setting level of the background removal unit 1071 is not limited to this. Therefore, next, a limitation that is put on the setting level of the background removal unit 1071 when the blank page determination level of the blank sheet detection unit 1064 has been increased, i.e., has been set so that image data is more likely to be determined to represent a blank sheet, will be described.

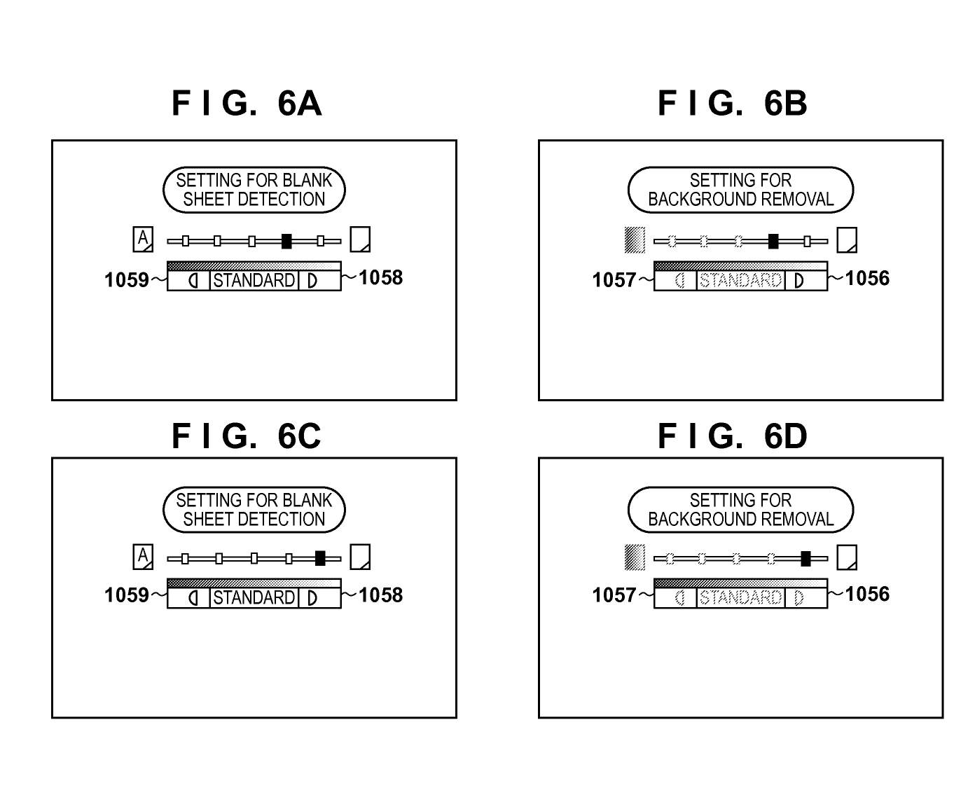

FIGS. 6A-6D are diagrams showing a limitation that is put on the background removal unit 1071 when the level of blank sheet detection of the blank sheet detection unit 1064 has been increased. FIG. 6A shows a case where the level of blank sheet detection of the blank sheet detection unit 1064 has been set to be immediately higher than the standard level (initial setting) by pressing down the setting key 1058, so that image data is more likely to be determined to represent a blank sheet. Because the level of blank sheet detection performed by the blank sheet detection unit 1064 has been set to be immediately higher than the standard level, i.e., image data is more likely to be determined to be a blank sheet, the control unit 101 controls the process of the background removal unit 1071 so that the acceptable range of the background removal correction process can be extended toward highlight (white) by one level. Specifically, as shown in FIG. 6B, the acceptable range of the background removal correction process contains the four lowest levels, and the highest level is grayed out and cannot be chosen. In other words, unlike FIGS. 5B and 5C, the display indicates that the threshold used in background removal can be decreased.

Also, even when, as shown in FIG. 6C, the level of blank sheet detection of the blank sheet detection unit 1064 is set so that image data is most likely to be determined to represent a blank sheet, the control unit 101 controls the process of the background removal unit 1071 to allow the maximum highlight (white) correction process (background removal correction process) as shown in FIG. 6D. In other words, the display indicates that the threshold used in background removal can be decreased.

Specifically, the control unit 101 changes the display of the operation unit 105 to allow only a background removal level(s) corresponding to the set blank sheet detection level to be chosen. Note that, in FIGS. 6B and 6D, the background removal level is changed to the lower limit of the levels that can be chosen. If the original setting level is the standard level (middle), which is within the acceptable range, the current setting level of background removal may be maintained.

After having displayed background removal levels corresponding to the setting level of blank sheet detection, the control unit 101 waits for a background removal level being chosen or input (NO in step S104). In this situation, the user of the image forming apparatus used in this embodiment can choose background removal levels only within a region corresponding to the setting level of blank sheet detection. Therefore, it is not acceptable to set a level that is not based on the correlation between processing units, e.g., it is not acceptable to set the background removal level to the maximum level irrespective of the setting level of blank sheet detection that has been set so that image data is less likely to be determined to represent a blank sheet, etc. Thus, as the setting level of blank sheet detection decreases, image data is less likely to be determined to represent a blank sheet. In this case, the acceptable setting level of background removal is controlled to be lower (a reduced effect of background removal) so that image data is less likely to be determined to represent a blank sheet. Conversely, as the setting level of blank sheet detection increases, image data is more likely to be determined to represent a blank sheet. In this case, the acceptable setting level of background removal is controlled to be higher (an increased effect of background removal) so that image data is more likely to be determined to represent a blank sheet.

When the user of the image forming apparatus used in this embodiment chooses or inputs one from the acceptable background removal levels (YES in step S104), the control unit 101 begins controlling original document image data. Specifically, the image input unit 106 is controlled to read original document image data (step S105), and the image processing unit 107 is controlled to perform image processing to read an image (step S106). The control unit 101 performs a control so that image data output from the image input unit 106 is transferred to the storage unit 108 via the DMAC 111 (step S107). Thereafter, when a page of image data output by the image input unit 106 has been transferred, the control unit 101 obtains the result of blank page determination output by the blank sheet detection unit 1064 included in the image input unit 106 (step S107). If the obtained blank page determination result indicates a “blank sheet” (YES in step S109), the control unit 101 determines that image data stored in the storage unit 108 represents a blank sheet, and deletes the stored data and ends the process (step S110). If the blank page determination result obtained from the image input unit 106 does not indicate a “blank sheet” (NO in step S109), the control unit 101 performs a control so that the image data stored in the storage unit 108 is transferred to the image processing unit 107 via the DMAC 111 in order to perform the background removal process (step S111). The background removal process is performed on the image data transferred to the image processing unit 107, and the resultant data is output. The power (threshold) indicating the level of the background removal process performed by the image processing unit 107 is limited in association with the setting level of blank sheet detection, and therefore, the background removal process causes image data to be less likely to be determined to represent a blank sheet. Specifically, a process result based on an appropriate background removal process is obtained. The control unit 101 performs a control so that the background-removed image data is transferred to the storage unit 108 via the DMAC 111. When the image data after the background removal process is stored into the storage unit 108, the control unit 101 performs a control so that the image data is transferred to the image transmission unit 110 via the DMAC 111 (step S112). The image transmission unit 110 successively outputs image data transferred from the storage unit 108 to the communication network 113.

Next, a case where the setting level of blank sheet detection has not been changed by the user will be described. During the start of transmission operation, if the control unit 101 determines that the setting level of blank sheet detection has not been changed from the initial value (middle value), the control unit 101 goes to a control corresponding to the situation that the setting level of blank sheet detection has not been changed (NO in step S101). If the setting level of blank sheet detection has not been changed, the control unit 101 determines whether or not the setting level of background removal has been changed from the initial value (middle value) (step S121).

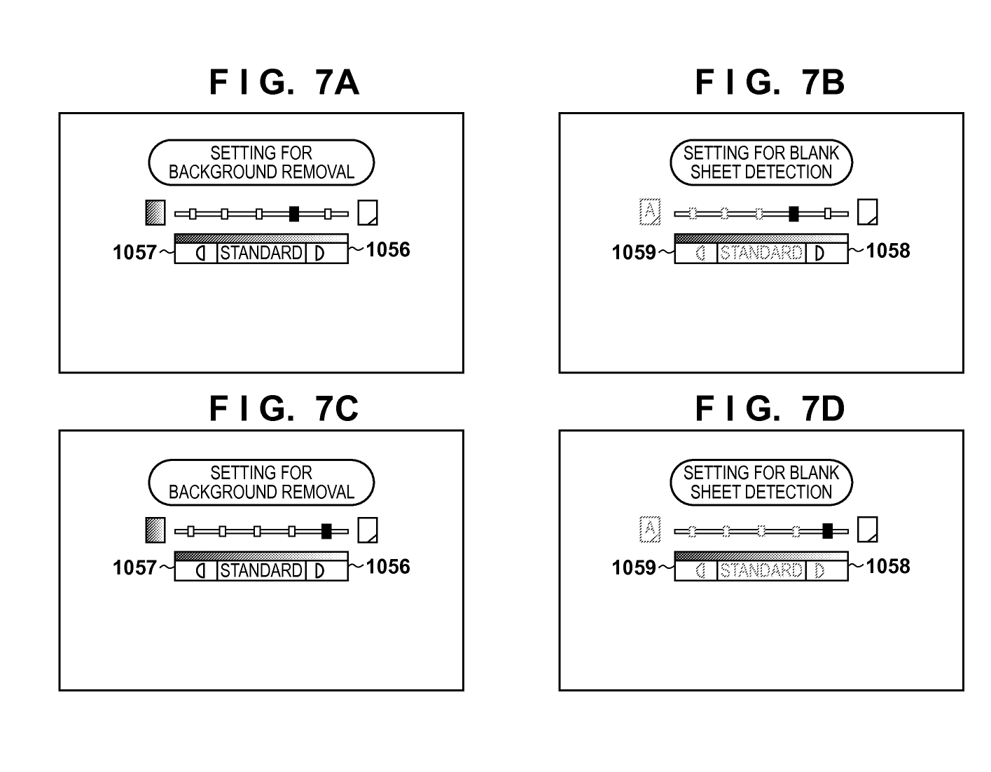

If the setting level of the background removal as well as the setting level of blank sheet detection have not been changed from the initial value (middle value), the control unit 101 performs the controls of steps S105 to S112 described above (NO in step S121). If the setting level of background removal has been changed from the initial value (middle value), the control unit 101 goes to a control corresponding to the situation that the setting level of background removal has been changed (YES in step S121). If, as shown in FIG. 7A, the setting level of background removal in the operation unit 105 has been changed by pressing down the setting key 1056 to a level that is immediately higher than the initial level so that the background removal process performs enhanced correction, the control unit 101 obtains the acceptable level(s) of the blank sheet detection unit 1064 corresponding to the setting level of background removal shown in FIG. 7A (step S122).

Thereafter, the control unit 101 changes the display of the obtained blank sheet detection level(s) to which the blank sheet detection unit 1064 cannot be set so that the blank sheet detection level cannot be chosen (step S123). FIG. 7B shows levels to which the blank sheet detection unit 1064 can be set when the process level of the background removal by the background removal unit 1071 is as shown in FIG. 7A. In FIG. 7A, the setting level of the background removal unit 1071 has been set to a level that is immediately higher than the initial value for enhanced correction (the effect of background removal is likely to be achieved). Therefore, in the blank sheet detection unit 1064, a mismatch may occur if blank page determination is performed based on a setting for which image data is less likely to be determined to represent a blank sheet. In other words, image data that has been determined by the blank sheet detection unit 1064 not to represent a blank sheet may be determined to indicate blank sheet due to the correction performed by the background removal unit 1071. Therefore, during transmission operation, even when the setting level of the background removal process performed by the background removal unit 1071 has been changed, the control unit 101 controls the blank sheet detection unit 1064 and the background removal unit 1071 so that the blank page determination process and the background removal process thereof appropriately function. Specifically, the control unit 101 limits the range of the setting level of blank sheet detection within which the blank sheet detection unit 1064 can be set, based on the setting level of the background removal unit 1071. Specifically, the acceptable level(s) of the blank sheet detection unit 1064 corresponding to the setting level of the background removal unit 1071 is obtained, and based on the result, only a setting level(s) to which the blank sheet detection unit 1064 can be set can be chosen. FIG. 7B shows this situation, showing a display (gray color) indicating that, as the setting of the blank sheet detection unit 1064, a criterion for blank page determination by the blank sheet detection unit 1064, which provides a determination level at which image data is less likely to be determined to represent a blank sheet, cannot be chosen.

FIG. 7C shows a situation that the setting level of the background removal unit 1071 has been set to be two levels higher than the initial level for enhanced correction (the effect of background removal is more likely to be achieved). FIG. 7D shows a level to which the blank sheet detection unit 1064 can be set in this situation. Because the setting level of the background removal process of the background removal unit 1071 has been set to the maximum level for most enhanced correction, the control unit 101 proportionately limits a setting level relating to a criterion for determining that image data represents a blank sheet. Specifically, the control unit 101 sets the criterion for determining that image data represents a blank sheet by the blank sheet detection unit 1064 so that only a setting for which image data is most likely to be determined to represent a blank sheet can be chosen. Specifically, when the setting level of blank sheet detection is as shown in FIG. 7C, the control unit 101 provides a display (gray color) indicating that the setting key 1059 cannot be pressed down as shown in FIG. 7D.

In FIGS. 7A-7D, the level of the background removal process is increased, i.e., is set so that the effect of the background removal process by the background removal unit 1071 is likely to be achieved, whereby an output image is converted into a level closer to highlight (white). Therefore, the setting level of the blank sheet detection unit 1064 is limited so that image data is more likely to be determined to represent a blank sheet. Therefore, when, as in the case where the setting level of the blank sheet detection unit 1064 is set first (YES in step S101), the level of the background removal process is decreased, i.e., the background removal process by the background removal unit 1071 is not performed to a large extent, there is a correlation between the setting levels. A limitation that is put on the setting of the blank sheet detection unit 1064 when the setting level of the background removal unit 1071 is decreased will now be described.

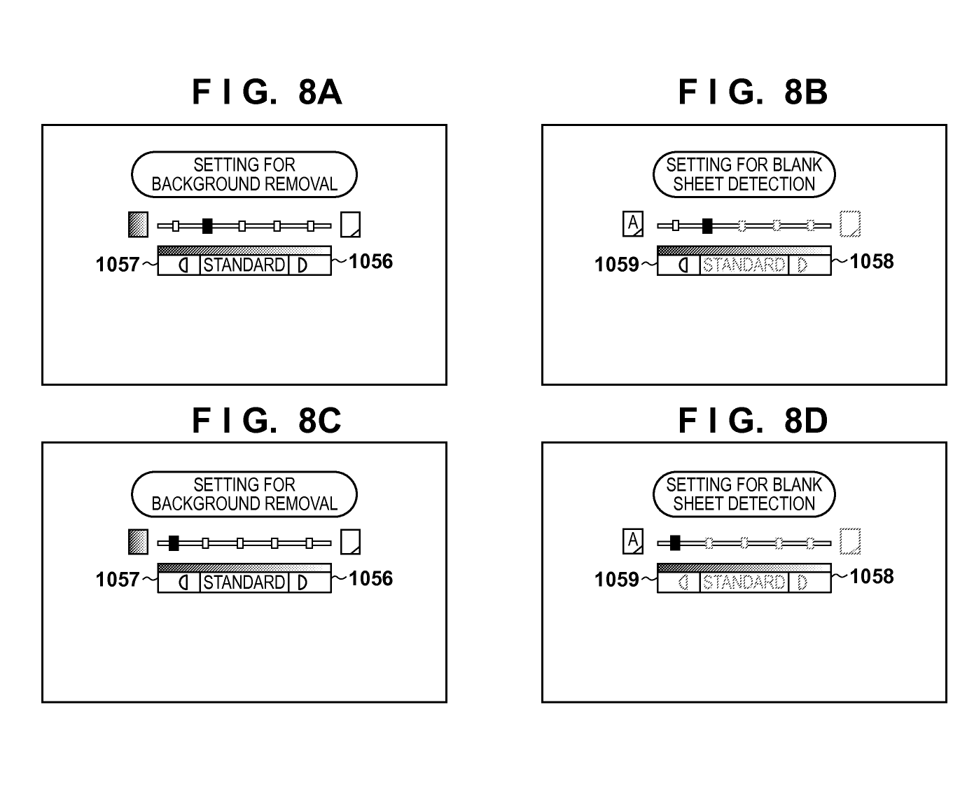

FIGS. 8A-8D are diagrams showing a limitation that is put on the blank sheet detection unit 1064 when the level of background removal of the background removal unit 1071 is decreased. FIG. 8A shows a case where the setting level of the background removal process of the background removal unit 1071 has been set to a level that is immediately lower than the initial value by pressing down the setting key 1057, i.e., the background removal process is not to be performed to a large extent. Because the background removal process by the background removal unit 1071 is decreased to a level that is immediately lower than the initial level, the control unit 101 extends the acceptable range of the setting level of blank page determination of the blank sheet detection unit 1064 to a level at which image data is less likely to be determined to represent a blank sheet (FIG. 8B). Also, when, as shown in FIG. 8C, the background removal process of the background removal unit 1071 has been set to the minimum level, the control unit 101 performs a control so that all setting levels of blank sheet detection of the blank sheet detection unit 1064 can be chosen. Specifically, the control unit 101 changes the display of the operation unit 105 so that only a blank sheet detection level(s) corresponding to the current setting level of background removal can be chosen (FIG. 8D).

After having displayed the blank sheet detection level(s) corresponding to the setting level of the background removal, the control unit 101 waits for a blank sheet detection level being input (NO in step S114). In this situation, the user of the image forming apparatus of this embodiment can choose a level only within the range of the blank sheet detection level corresponding to the setting level of the background removal. Therefore, it is not allowable to set a level that is not based on the correlation between processing units. When the user of the image forming apparatus used in this embodiment chooses or inputs one from the blank sheet detection levels that can be chosen (YES in step S114), the control unit 101 goes to the following controls. Specifically, the control unit 101 controls steps S105-S112 to be executed.

Although it is assumed in the above description of transmission operation that the setting level of background removal and the setting level of blank sheet detection are changed by the same number of levels at a time, the present invention is not limited to this. Specifically, a limitation that is put on the setting level of blank page determination when the setting level of the background removal is changed by one level, may be two levels. More specifically, when, as shown in FIG. 5A, the setting level of blank sheet detection has been set to a level that is immediately lower than the initial level, i.e., image data is less likely to be determined to represent a blank sheet, the level of background removal that can be chosen may be a level at which the background removal process is performed to the minimum extent as shown in FIG. 5D. Also, although it is assumed in the above specific example that the setting level of blank sheet detection is decreased by one level, the setting level may be set to a higher level, or the background removal level may be set first. Moreover, because it is only necessary to maintain a correlation between the setting levels, there may be three setting levels of blank sheet detection while there may be seven setting levels of background removal.

In any case, in order to reduce or prevent the outputting of image data representing a blank sheet, it is necessary to reduce or prevent a situation that the lightness of image data that has been determined by blank sheet detection not to represent a blank sheet and has been determined to contain any contents, is converted by background removal, so that the image data is converted into that represents a blank sheet. Here, it is assumed that as the setting level of blank sheet detection decreases, image data is less likely to be determined to represent a blank sheet, and as the setting level of background removal decreases, image data is less likely to be determined to represent a blank sheet. It is also assumed that the setting level of blank sheet detection for determining that a read original document image is blank, is the same as the setting level of background removal for converting the same original document into a blank sheet (FIGS. 5A-5D, FIGS. 6A-6D, FIGS. 7A-7D, FIGS. 8A-8D, etc. show examples based on this assumption). In this case, the setting level of background removal needs to be lower than or equal to the setting level of blank sheet detection. This is because, otherwise, the difference between the levels causes image data that has been determined not to represent a blank sheet to be converted into that which represents a blank sheet. Here, a parameter that is a determination criterion for blank sheet detection is different from a parameter of the power of background removal, and therefore, it is difficult to match the setting levels by matching the parameters. However, for example, a parameter for blank sheet detection and a parameter for background removal that, if an original document is the same, determines that the original document is blank and converts the original document into a blank sheet, respectively, may be empirically determined. If these parameters are determined for five levels, the setting levels can be mutually limited as shown in FIGS. 5A-8D.

### Second Embodiment

Next, a case where an image forming apparatus used in a second embodiment is operated in an operation mode in which printing or outputting is performed, will be described with reference to other figures. In the second embodiment, a parameter for density correction may be provided. The relationship between the setting levels of blank sheet detection and background removal is similar to that of the first embodiment. The density correction may be dealt with in a manner similar to that of background removal, because as the density decreases (the level increases), an image is more likely to be determined to be blank. Therefore, the relationship between the setting levels of blank sheet detection and density correction is similar to the relationship between the setting levels of blank sheet detection and background removal in the first embodiment.

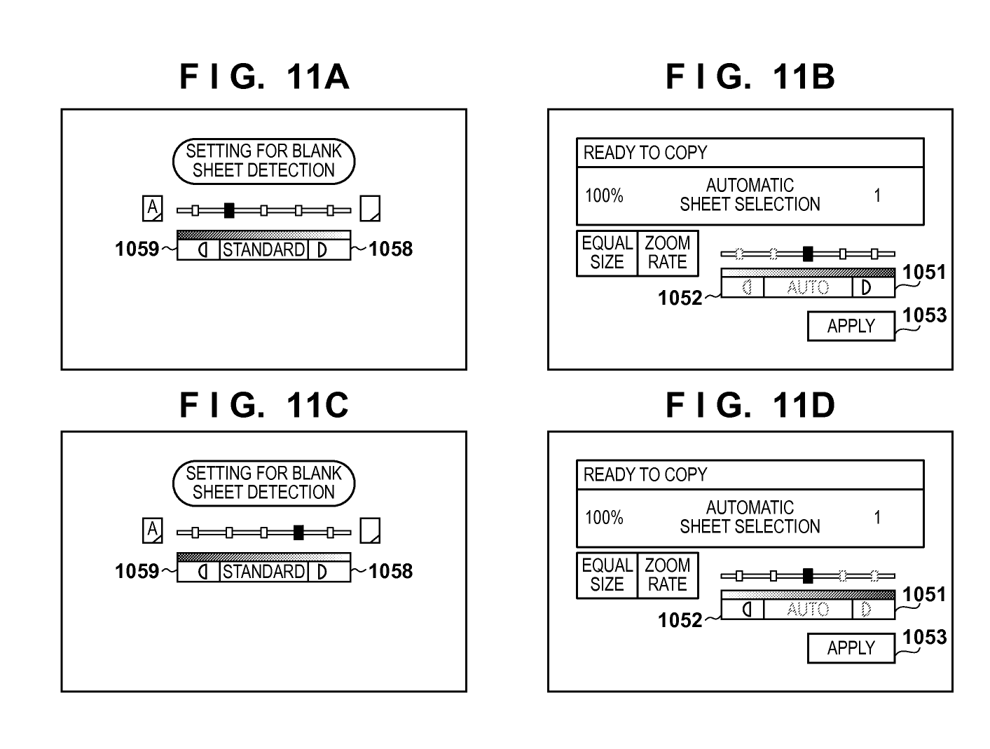

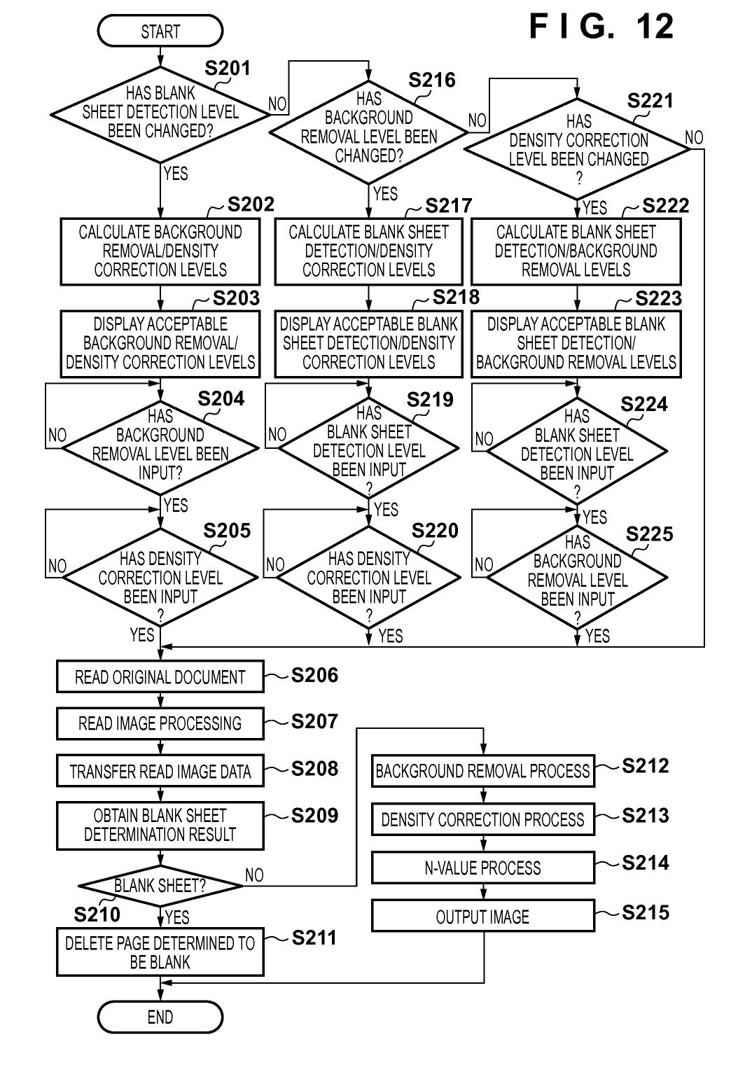

FIG. 12 is a control flow that is performed when the image forming apparatus used in this embodiment is operated in an operation mode in which printing or outputting is performed. When the user provides an instruction to perform printing or outputting by making a setting in the operation unit 105, the control unit 101 checks the setting level of blank sheet detection for printing or outputting. The control unit 101, when confirming that the setting level of blank sheet detection has been changed from the initial value (middle value) in the operation unit 105, goes to a control corresponding to the situation that the setting level of blank sheet detection has been changed (YES in step S201). Next, the control unit 101 obtains a background removal level(s) and a density correction level(s) corresponding to the set blank sheet detection level (step S202), and for each type of level, displays only an acceptable level(s) in a form that allows the user to choose them (step S203). For example, when the set blank sheet detection level is such that image data is likely to be determined to represent a blank sheet, no lower background level and no higher density correction level can be chosen, i.e., it is not allowable to decrease the background removal level or choose a density correction level that allows for enhanced correction. Conversely, when the set blank sheet detection level is such that image data is unlikely to be determined to represent a blank sheet, no higher background removal level and no lower density correction level can be chosen, i.e., it is not allowable to increase the background removal level or choose a density correction level that allows for reduced correction. An example is shown in FIGS. 11A-11D.

FIG. 11A shows a setting for blank sheet detection that is immediately lower than the initial level, i.e., image data is less likely to be determined to represent a blank sheet. Note that the setting for blank sheet detection and the setting for background removal have been described above in the description of transmission operation and will not be here described. As shown in FIG. 11A, when the setting for blank sheet detection has been set to be immediately lower than the initial level, i.e., image data is less likely to be determined to represent a blank sheet, a case may be assumed where when the density of an original document to be read originally has a low density, the user does not desire that low-density image data should be determined to represent a blank sheet. Therefore, if a low-density setting is allowed as the setting for density correction in this case, printed or output image data is highly likely to represent a blank sheet. Therefore, in the setting of the blank page determination level, the setting for density correction is controlled so that a lower density setting cannot chosen. FIG. 11B shows this situation, indicating that the setting key 1052 that is pressed down to decrease the density is displayed in a form (gray color) that does not allow the setting key 1052 to be chosen. As shown in FIG. 11C, when the setting level of blank sheet detection has been set to be immediately lower than the initial level, i.e., image data is more likely to be determined to represent a blank sheet, a case may be assumed where the density of an original document to be read may originally have a high density. If a high-density setting is allowed as the setting for density correction in this case, printed or output image data is less likely to be recognized as a blank sheet. Therefore, in the setting of the blank page determination level, density correction is limited so that a higher density setting cannot chosen. Specifically, as shown in FIG. 11D, the setting key 1051 is displayed in a form (gray color) that does not allow the setting key 1051 to be chosen. In this case, it is desirable to assume that even if density correction is set so that the density is decreased to the minimum level, image data is not determined to represent a blank sheet.

When the user chooses or inputs one from the background removal levels that can be chosen (step S204), and one from the density correction levels that can be chosen (step S205), the control unit 101 begins controlling reading of original document image data. The control unit 101 controls the image input unit 106 to read original document image data (step S206), and perform read image processing (step S207). The image data read by the image input unit 106 and the result of blank page determination are transferred to the storage unit 108 by the DMAC 111 under the control of the control unit 101 (step S208). The control unit 101 obtains the blank page determination result stored in the storage unit 108 (step S209), and goes to a control according to the blank page determination result. If the image data read by the image input unit 106 has been determined to represent a blank sheet (YES in step S210), the control unit 101 deletes the read image data stored in the storage unit 108, and ends the process (step S211). If the image data read by the image input unit 106 has been determined not to represent a blank sheet (NO in step S210), the control unit 101 goes to a control for printing or outputting. Specifically, the read image data stored in the storage unit 108 is transferred to the image processing unit 107 via the DMAC 111. The image processing unit 107 performs the background removal process on the image data transferred by the DMAC 111 using a setting value that is based on the set background removal level (step S212). Next, a density correction process is performed on the image data on which the background removal process has been performed, using a setting value that is based on the set density correction level (step S213). The level of the background removal process to be performed and the level of the density correction process to be performed are limited within a range corresponding to the blank sheet detection level that has been set by the user during the start of printing operation, and therefore, the correction is not performed to an excessive extent. In other words, the correction is performed within an appropriate range. Next, an N-value process is performed on the image data on which the density correction process has been performed (step S214). The control unit 101 transfers the image data on which the image processing unit 107 has performed the N-value process to the storage unit 108 via the DMAC 111. Thereafter, the control unit 101 transfers the image data on which the N-value process has been performed and that is stored in the storage unit 108, via the DMAC 111 to the image output unit 109, which then outputs an image (step S215).

Next, a case where the user has not set the blank sheet detection level during the start of printing operation (NO in step S201) will be described. If the blank sheet detection level has not been set, the control unit 101 checks whether or not the background removal level has been changed from the initial value (middle value) (step S216). The control unit 101, when confirming that the user has changed the background removal level (YES in step S216), goes to a control corresponding to this case. Specifically, the control unit 101 obtains a blank sheet detection level(s) and a density correction level(s) corresponding to the set background removal level (step S217), and displays the obtained correction levels in a form that only allows these correction levels to be chosen (step S218). The control unit 101 waits for the user choosing or inputting a blank sheet detection level within a range that allows the user to choose (step S219), and a density correction level within a range that allows the user to choose (step S220). When the user chooses or inputs a blank sheet detection level and a density correction level, the control unit 101 goes to the following controls. Specifically, the control unit 101 controls steps S206-S215 based on the blank sheet detection result output by the image input unit 106.

Next, a case where the user has not changed the blank sheet detection level or the background removal level from the respective initial values (middle values) during the start of printing operation (NO in step S201 and NO in step S216), will be described. When none of the blank sheet detection level and the background removal level has been set, the control unit 101 checks whether or not the density correction level have been changed from the initial value (middle values) (step S221). The control unit 101, when confirming that the user has not changed the density correction level, performs a printing operation control using the blank sheet detection level, the background removal level, and the density correction level that have the respective initial values (middle values) (NO in step S221). Specifically, the control unit 101 performs steps S206-S215 based on the blank sheet detection result output by the image input unit 106.

In step S221, the control unit 101, when confirming that the density correction level has been changed (YES in step S221), goes to a control corresponding to this case. Specifically, the control unit 101 obtains a blank sheet detection level(s) and a background removal level(s) corresponding to the set density correction level (step S222), and displays the obtained correction levels in a form that only allows the correction levels to be chosen (step S223). The control unit 101 waits for the user choosing or inputting a blank sheet detection level within a range that allows the user to choose (step S224), and a background removal level within a range that allows the user to choose (step S225). When the user chooses or inputs a blank sheet detection level and a background removal level, the control unit 101 goes to the following controls. Specifically, the control unit 101 performs steps S206-S215 based on the blank sheet detection result output by the image input unit 106.

According to this embodiment, in addition to advantages similar to those of the first embodiment, a limitation can be put on the setting level of density correction based on the setting levels of blank sheet detection and background removal. Conversely, a limitation can be put on the setting levels of blank sheet detection and background removal based on the setting level of density correction. As a result, the outputting of a blank sheet can be reduced or prevented.

Thus, as a result of image processing on image data that has been determined not to represent a blank sheet as a result of blank sheet detection, the outputting of the image data as a blank sheet can be reduced or prevented.

### Third Embodiment

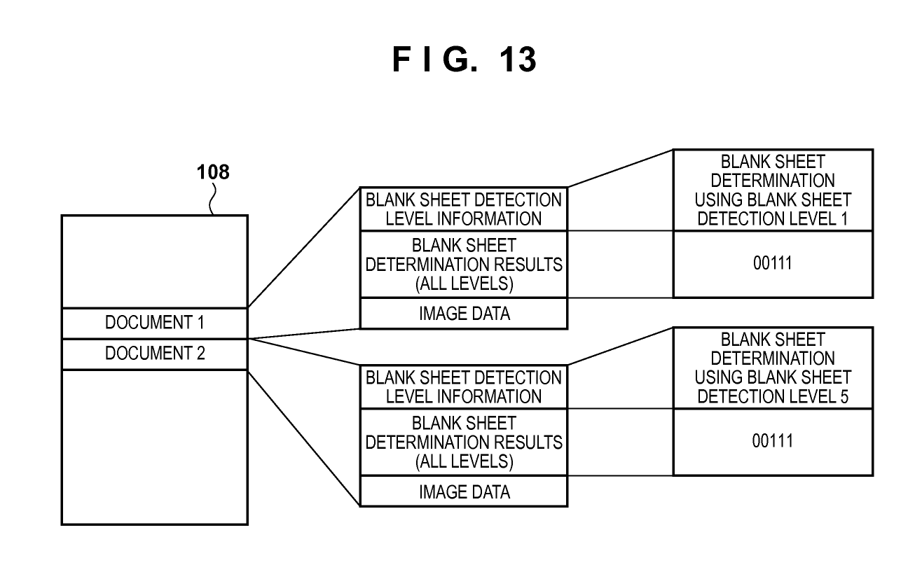

Next, a case will be described with reference to FIG. 13 where the image forming apparatus used in this embodiment does not perform printing or outputting immediately after obtaining original document image data (i.e., after original document image data is obtained, the read image data is stored in a storage unit of the apparatus, and will be printed or output after a period of time, i.e., at another time). The apparatus has a configuration etc. similar to those of the first embodiment. FIG. 13 is a diagram showing a configuration of the storage unit 108 when the image forming apparatus used in this embodiment is operated in the above operation mode. In FIG. 13, the storage unit 108 stores two documents (a document 1 and a document 2). For data of each document, blank sheet detection level information and a blank page determination result are stored together with read image data under the control of the control unit 101. The blank sheet detection level information indicates a blank sheet detection level set by the user during reading of original document image data. For example, the blank sheet detection level of original document image data that has been set by the user so that image data is most likely to be determined to represent a blank sheet is represented by “level 1,” and the blank sheet detection level of original document image data that has been set by the user so that image data is least likely to be determined to represent a blank sheet is represented by “level 5.” In this case, the document 1 indicates that the blank page determination has been performed using the level at which image data is most likely to be determined to represent a blank sheet, and the document 2 indicates that the blank page determination has been performed using the level at which image data is least likely to be determined to represent a blank sheet. The storage unit 108 stores the results of all levels that can be chosen for blank sheet detection. Note that it is here assumed that there are five levels that can be chosen as the blank sheet detection level. The results of blank page determination for the five levels are represented by a 5-digit numerical value, where the rightmost digit indicates the result of blank page determination for level 1. It is assumed that, as the blank page determination result, “0” indicates that image data does not represent a blank sheet, and “1” indicates that image data represents a blank sheet. The document 1 has been read using the blank sheet detection level 1 during reading of original document image data, and therefore, the corresponding blank page determination result is represented by “1,” indicating that the image data represents a blank sheet. The document 2 has been read using the blank sheet detection level 5 during reading of original document image data, and therefore, the corresponding blank sheet detection result is represented by “0,” indicating that the image data does not represent a blank sheet.

Note that the reason why all blank page determination results are stored in the storage unit 108 is that the determination levels of blank sheet detection can be changed during printing or outputting. Specifically, this is effective when the user desires to change, during printing or outputting, the blank sheet detection levels that have been used during reading of an original document. When, as the blank sheet detection result, only the determination result based on the blank sheet detection level chosen during reading of an original document is stored, the same original document needs to be read again if a determination result based on a different blank sheet detection level is desired. However, if the determination results have been obtained for all blank sheet detection levels that can be chosen during reading of an original document and have been stored, then when stored image data is printed, a control using the determination result that is based on a different blank sheet detection level can be performed. In an example shown in FIG. 13, when the user desires to deal with the document 1 on which the blank sheet detection has been performed using the blank sheet level 4, the blank page determination result represented by “0” can be used without reading original document image data again, because the blank page determination results based on all blank sheet detection levels are stored.

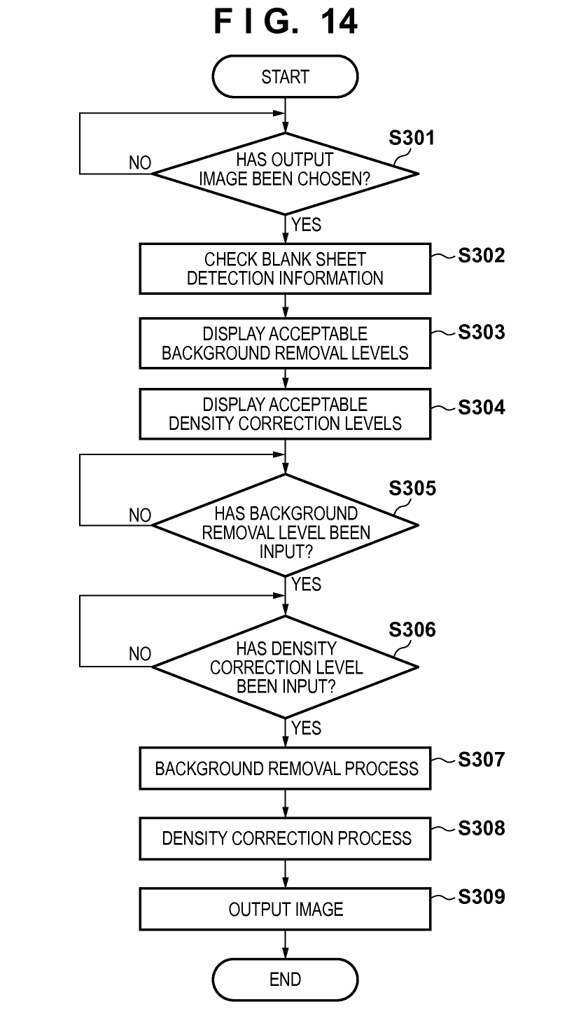

A control flow will be described with reference to FIG. 14 that is performed when the image forming apparatus used in this embodiment does not print or output original document image data immediately after the data is obtained (i.e., original document image data that has been obtained is stored in a storage unit of the apparatus, and will be printed or output at another time). FIG. 14 is a diagram showing a control that is performed in this operation mode. If the user has chosen image data stored in the storage unit 108 (YES in step S301), the control unit 101 checks blank sheet detection information stored in the storage unit 108 (step S302). The control unit 101 obtains, based on the checked blank sheet detection information, a level(s) that can be chosen for the background removal process and a level(s) that can be chosen for the density correction process, and displays these levels while putting a limitation on setting levels of the operation unit 105 (steps S303 and S304). This is as described in the first and second embodiments. Note that, in this embodiment, after image data to be printed or output has been chosen, instead of using the blank sheet detection level information stored in the storage unit 108, another blank sheet detection result may be used according to an instruction in the operation unit 105. For example, during printing or outputting of the document 1, although it is indicated that blank sheet detection has been performed using the blank sheet detection level 1 in the case where read original document image data is stored, printing or outputting may be performed by choosing the blank sheet detection level 2 during printing or outputting. In this case, a level(s) that the user can choose for the background removal process and a level(s) that the user can choose for the density correction process, corresponding to the chosen blank sheet detection level 2, are obtained, and are displayed while putting a limitation on setting levels of the operation unit 105.

If the user has chosen or input one from the background removal levels within a range that allows the user to choose and the density correction levels within a range that allows the user to choose (steps S305 and S306), the control unit 101 transfers image data to be printed or output that is stored in the storage unit 108, to the image processing unit 107 via the DMAC 111. The image processing unit 107 performs the background removal process and the density correction process on the image data transferred from the DMAC 111 (steps S307 and S308). The control unit 101 performs a control so that the image data on which the background removal process and the density correction process have been performed, which is output by the image processing unit 107, is transferred to the storage unit 108 via the DMAC 111. Thereafter, the control unit 101 transfers the image data on which the density correction process has been performed, which is stored in the storage unit 108, to the image output unit 109 via the DMAC 111. The image output unit 109 outputs the image data transferred from the DMAC 111 to complete printing or outputting (step S309).

As described above, in the control during printing or outputting of the image forming apparatus used in this embodiment, the correlation between the blank sheet detection levels and the setting parameters during printing or outputting can be maintained. Therefore, a situation can be reduced or prevented that although image data has been determined not to represent a blank sheet as a result of blank sheet detection, the image data is output as a blank sheet as a result of image processing on the image data.

Although it is assumed above that background removal and density correction are performed as correction that is performed based on the setting level of blank sheet detection, the present invention is not limited to this. Specifically, the present invention can be applied to all limitations (choice) on correction processes that need to be correlated with each other during printing or outputting, with respect to processes of outputting a plurality of determination results for read image data.

### Fourth Embodiment

The first to third embodiments have been described in which, during transmission operation or printing or outputting, the background removal level or the density correction level are limited to those which are correlated with the blank sheet detection level set in the operation unit 105, and the other levels cannot be chosen from the operation unit 105. However, the present invention is not limited only to this form. A fourth embodiment of the present invention will now be described.

In the fourth embodiment, the correction range that can be set based on the blank sheet detection level chosen by the operation unit 105 is divided into predetermined levels. For example, it is assumed that, in the first embodiment, for a blank sheet detection level chosen by the operation unit 105, there are three background removal levels that can be chosen. In this case, in the first embodiment, two levels cannot be chosen (displayed in gray). However, in this embodiment, the correction range (correction values) corresponding to the three levels that can be chosen is sub-divided into 5 levels. In other words, for the blank sheet detection level chosen by the operation unit 105, instead of limiting levels to be chosen, the same number of levels as there are the levels provided in the operation unit 105 can be chosen.

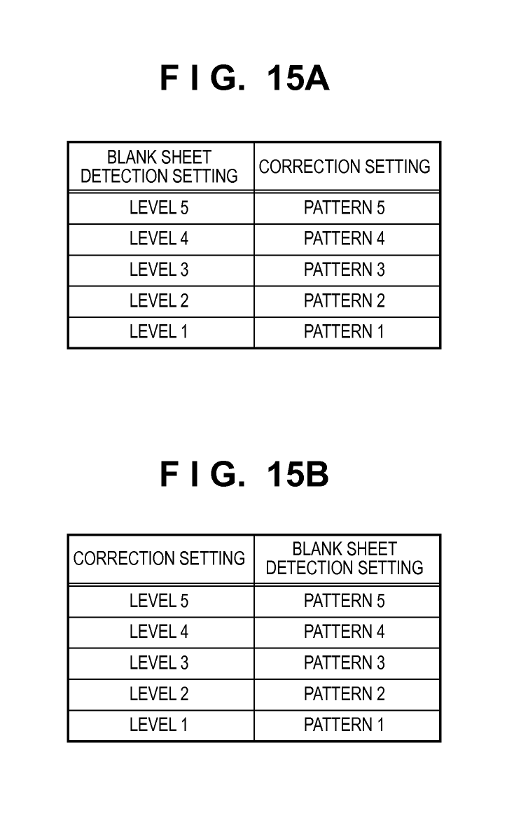

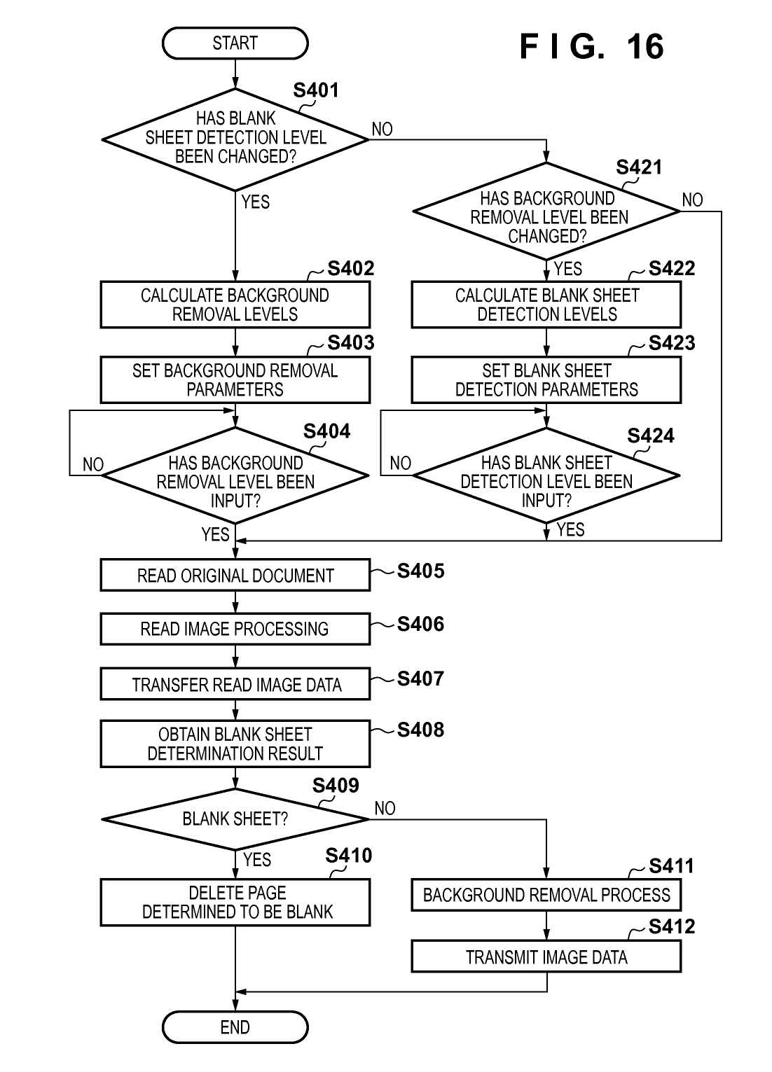

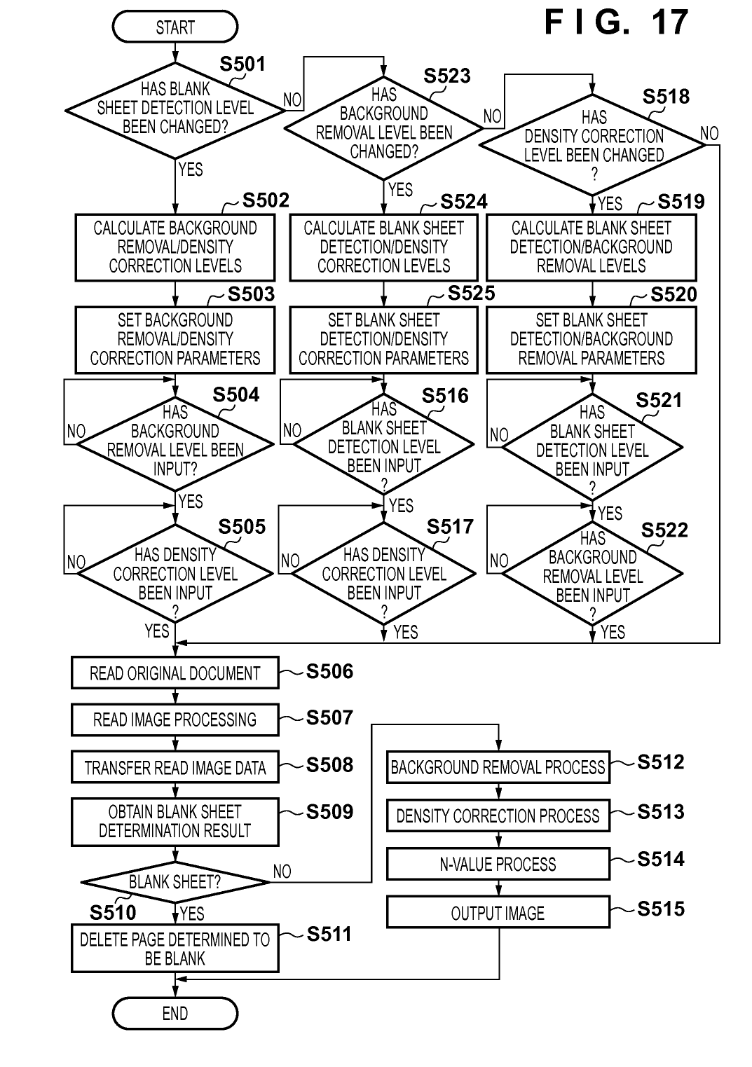

FIGS. 15A and 15B are diagrams showing the concept of a parameter configuration corresponding to blank sheet detection levels that the user can choose. Note that it is here assumed that there are five setting levels of blank sheet detection. For the five blank sheet detection levels, in order to allow for five correction settings, it is necessary to obtain five correction settings corresponding to each blank sheet detection level. Therefore, a correction range that is allowed for each blank sheet detection level is obtained as a set of five parameters. For example, when the blank sheet detection setting is level 4, pattern 4 is obtained that is obtained by dividing, into five levels, the correction range of a correction process that is allowed by the blank sheet detection setting. Specifically, when the user chooses level 4 as the blank sheet detection setting, the control unit 101 sets the correction process levels to pattern 4. Note that each pattern is preferably previously determined. This is because there are a plurality of blank sheet detection parameters, and a single setting level is determined by a combination thereof, and therefore, if a relationship between the setting levels and the parameters is previously determined, the accuracy and efficiency are improved.

A control of the control unit 101 in this embodiment will now be described. FIG. 16 shows a control flow that is performed by the image forming apparatus used in this embodiment during transmission operation. In FIG. 16, a characteristic feature of this embodiment is steps S403 and S413. In FIG. 16, steps S103 and S113 of FIG. 9 are replaced with steps S403 and S413, respectively. Therefore, the following description is slightly different from that of FIG. 9, but the same description is provided for steps other than steps S403 and S413.

The control unit 101 checks whether or not the blank sheet detection level has been changed from the initial value (middle value) by the user. The control unit 101, when confirming that the blank sheet detection level has been changed according to the setting of the operation unit 105 (YES in step S401), goes to a control corresponding to the situation that the blank sheet detection level has been changed. The control unit 101 obtains a background removal level(s) corresponding to the blank sheet detection level set by the operation unit 105 (step S402), and divides the background removal level into levels that can be chosen for the background removal process, in the operation unit 105, to set parameters (step S403). Referring to FIGS. 15A and 15B, if the set blank sheet detection level is “1,” pattern 1 of correction setting of background removal corresponding to this is set with respect to each setting level of background removal. Correction values set for the respective levels have a narrowed setting width because the entire correction range of background removal is narrowed by the blank sheet detection level set in the operation unit 105.

The control unit 101 waits for the user choosing or inputting a background removal process level (NO in step S404). The control unit 101, when confirming that a background removal process level has been chosen or input (YES in step S404), begins controlling transmission operation of read image data. Specifically, the control unit 101 controls the image input unit 106 to read original document image data and perform image processing on the read image data (steps S405 and S406). The image data processed by the image input unit 106, and the result of blank page determination, are transferred to the storage unit 108 by the DMAC 111 under the control of the control unit 101 (step S407). The control unit 101 obtains the blank page determination result stored in the storage unit 108 (step S408), and when the obtained blank page determination result indicates a blank sheet (YES in step S409), deletes the read image data stored in the storage unit 108, and ends the process (step S410). Note that when the blank page determination result obtained in step S408 does not represent a blank sheet, the control unit 101 continues to control transmission operation (NO in step S409). Specifically, the control unit 101 performs the background removal process using the setting value of the background removal process corresponding to the chosen blank sheet detection level (step S411). The control unit 101 transfers the image data on which the background removal process has been performed, which is output by the image processing unit 107, to the storage unit 108 via the DMAC 111. The control unit 101 transfers the image data transferred to the storage unit 108, to the image transmission unit 110 via the DMAC 111. The image transmission unit 110 outputs the image data transferred by the DMAC 111 to the communication network 113 to complete transmission operation (step S412).

In step S401, the control unit 101, when confirming that the blank sheet detection level has not been changed from the initial value (middle value) by the user (NO in step S401), goes to a control corresponding to the situation that the blank sheet detection level has not been changed. Next, the control unit 101 checks whether or not the background removal level has been changed from the initial value (middle value). The control unit 101, when confirming that the background removal level has not been changed from the initial value (middle value), performs steps S405-S412 (NO in step S411). The control unit 101, when confirming that the background removal level has been changed (YES in step S411), obtains a blank sheet detection level(s) corresponding to the background removal level set by the operation unit 105 (step S412), and divides the blank sheet detection level into levels that can be chosen for the blank sheet detection process, in the operation unit 105, to set parameters (step S413). As shown in FIGS. 15A and 15B, if the set correction setting level is “1,” pattern 1 for detection setting corresponding to this is set with respect to each setting level of blank sheet detection. The control unit 101 waits for the user choosing or inputting a blank sheet detection level (NO in step S414). The control unit 101, when confirming that a blank sheet detection level has been chosen or input (YES in step S414), begins controlling transmission operation of read image data. Specifically, the control unit 100 performs steps S405-S412. Thus, during transmission operation of the image forming apparatus used in this embodiment, the control unit 101 divides a setting range corresponding to a blank sheet detection level or a background removal level set by the user into setting levels, which are then set in a processing unit to be used, thereby controlling the apparatus so that the apparatus appropriately operates.

Next, a control flow that is performed during printing or outputting in this embodiment will be described. FIG. 17 shows a control flow that is performed by the image forming apparatus used in this embodiment during printing or outputting. In FIG. 17, steps S203, S218, and S223 of FIG. 12 are replaced with steps S503, S515, and S520. The control unit 101 checks whether or not the blank sheet detection level has been changed from the initial value (middle value) by the user. The control unit 101, when confirming that the blank sheet detection level has been changed in the setting of the operation unit 105 (YES in step S501), goes to a control corresponding to the situation that the blank sheet detection level has been changed. The control unit 101 obtains a background removal level(s) and a density correction level(s) corresponding to the blank sheet detection level set by the operation unit 105 (step S502), and divides these levels into levels that can be chosen for the background removal process and the density correction process, in the operation unit 105, to set parameters (step S503). Referring to FIGS. 15A and 15B, if the set blank sheet detection level is “1,” pattern 1 of correction setting of background removal corresponding to this is set with respect to each setting level of background removal, and pattern 1 of correction setting of density correction corresponding to this is set with respect to each setting level of density correction.

The control unit 101 waits for the user choosing or inputting a background removal process level and a density correction level (NO in step S504 and NO in step S505). The control unit 101, when confirming that each level has been chosen or input (YES in step S504 and YES in step S505), begins controlling transmission operation of read image data. Specifically, the control unit 101 controls the image input unit 106 to read original document image data and perform image processing on the read image data (steps S506 and S507). The image data processed by the image input unit 106, and the result of blank page determination, are transferred to the storage unit 108 by the DMAC 111 under the control of the control unit 101 (step S508). The control unit 101 obtains the blank page determination result stored in the storage unit 108 (step S509). The control unit 101, when the obtained blank page determination result represents a blank sheet (YES in step S510), deletes the read image data stored in the storage unit 108, and ends the process (step S511). Note that if the blank page determination result obtained in step S509 does not represent a blank sheet, the control unit 101 continues to control printing or outputting operation (NO in step S510). Specifically, the control unit 101 performs a control so that the background removal process and the density correction process that are image processing performed by the image processing unit 107 are performed using correction values corresponding to the blank sheet detection level set by the user (steps S512 and S513). The image processing unit 107 performs the N-value process on the image data on which the density correction process has been performed (step S514), and outputs the resultant image data. The control unit 101 transfers the image data on which the N-value process has been performed, which is output by the image processing unit 107, to the storage unit 108 via the DMAC 111. The control unit 101 transfers the image data transferred to the storage unit 108, to the image output unit 109 via the DMAC 111. The image output unit 109 outputs the image data transferred by the DMAC 111 to complete printing or outputting (step S515).

The control unit 101, when confirming in step S501 that the blank sheet detection level has not been changed from the initial value (middle value) by the user (NO in step S501), next checks whether or not the background removal level has been changed from the initial value (middle value). The control unit 101, when confirming that the background removal level has been changed from the initial value (middle value), goes to a control corresponding to the situation that the background removal level has been changed (YES in step S523). The control unit 101 obtains a blank sheet detection level(s) and a density correction level(s) corresponding to the background removal level set by the operation unit 105 (step S524), and divides the blank sheet detection level and the density correction level into levels that can be chosen for the blank sheet detection process and the density correction process, in the operation unit 105, to set parameters (step S525). Thereafter, the control unit 101 waits for the user choosing or inputting a blank sheet detection level and a density correction level (NO in step S516 and NO in step S517). The control unit 101, when confirming that a blank sheet detection level and a density correction level have been chosen or input (YES in step S516 and YES in step S517), begins controlling printing or outputting of read image data. Specifically, the control unit 101 performs steps S506-S515.

The control unit 101, when the background removal level has not been changed from the initial value (middle value) by the user in step S523 (NO in step S523), next checks whether or not the density correction level has been changed from the initial value (middle value). The control unit 101, when confirming that the density correction level has been changed from the initial value (middle value), goes to a control corresponding to the situation that the density correction level has been changed (YES in step S518). The control unit 101 obtains a blank sheet detection level(s) and a background removal level(s) corresponding to the density correction level set by the operation unit 105 (step S519), and divides the blank sheet detection level and the background removal level into levels that can be chosen for the blank sheet detection process and the background removal process, in the operation unit 105, to set parameters (step S520). Thereafter, the control unit 101 waits for the user choosing or inputting a blank sheet detection level and a background removal level (NO in step S521 and NO in step S522). The control unit 101, when confirming that a blank sheet detection level and a background removal level have been chosen or input (YES in step S521 and YES in step S522), begins controlling printing or outputting of read image data. Specifically, the control unit 101 performs steps S506-S515.

Thus, during printing or outputting in the image forming apparatus used in this embodiment, the control unit 101 divides the setting range corresponding to the blank sheet detection level, the background removal level, or the density correction level that has been set by the user into setting levels of a processing unit to be used, thereby controlling the apparatus so that the apparatus appropriately operates.

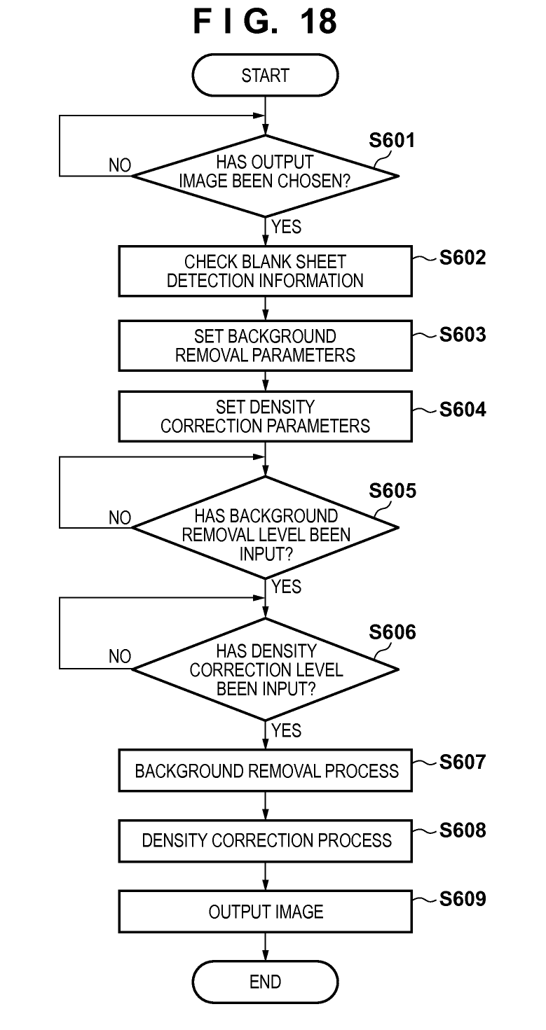

Next, a control flow will be described with reference to FIG. 18, that is performed in the image forming apparatus used in this embodiment when printing or outputting is not performed immediately after original document image data is obtained (i.e., after original document image data has been obtained, the read image data is stored in a storage unit of the apparatus, and will be printed or output at another time). FIG. 18 is a diagram showing a control that is performed in this operation mode. In FIG. 18, step S304 of FIG. 14 is replaced with step S604. When image data stored in the storage unit 108 has been chosen by the user (YES in step S601), the control unit 101 checks blank sheet detection information stored in the storage unit 108 (step S602). Based on the checked blank sheet detection information, the control unit 101 obtains a level(s) that can be chosen for the background removal process and a level(s) that can be chosen for the density correction process, and divides the correction ranges into levels, which are then set in the operation unit 105 (steps S603 and S604). Note that, also in the fourth embodiment of the present invention, after image data to be printed or output has been chosen, another blank sheet detection result may be used according to an instruction in the operation unit 105, instead of the blank sheet detection level information stored in the storage unit 108. For example, during printing or outputting of the document 1, although it is indicated that blank sheet detection has been performed using the blank sheet detection level 1 in the case where read original document image data is stored, printing or outputting may be performed by choosing the blank sheet detection level 2 during printing or outputting. In this case, the control unit 101 obtains a correction range that can be chosen for the background removal process and a correction range that can be chosen for the density correction process, which correspond to the blank sheet detection level 2 chosen by the user, and divides the correction ranges into levels, which are then set as setting levels in the operation unit 105.

If the user has chosen or input a background removal level within the range that can be chosen and a density correction level within the range that can be chosen (steps S605 and S606), the control unit 101 transfers image data to be printed or output that is stored in the storage unit 108, to the image processing unit 107 via the DMAC 111. The image processing unit 107 performs the background removal process and the density correction process on the image data transferred from the DMAC 111 (steps S607 and S608). The control unit 101 performs a control so that the image data on which the background removal process and the density correction process have been performed, which is output by the image processing unit 107, is transferred to the storage unit 108 via the DMAC 111. Thereafter, the control unit 101 transfers the image data on which the density correction process has been performed, which is stored in the storage unit 108, to the image output unit 109 via the DMAC 111. The image output unit 109 outputs the image data transferred from the DMAC 111 to complete printing or outputting (step S609).

As described above, in this embodiment, the value of the correction range obtained based on a setting level(s) of either of the blank sheet detection process, the background removal process, or the density correction process that is set by the user, is divided into setting levels for a process to be performed, whereby the apparatus can appropriately operate. By this control, in a control during printing or outputting, the correlation between the blank sheet detection levels and the setting parameters during printing or outputting is maintained. Therefore, a situation can be reduced or prevented that although image data has been determined not to represent a blank sheet as a result of blank sheet detection, the image data is output as a blank sheet as a result of image processing on the image data.

Also, in the fourth embodiment, even when a setting level for each of blank sheet detection, background removal, and density correction is chosen, the display of setting levels of other processes that can be chosen in the operation unit 105 is not changed. Therefore, the setting levels are automatically associated with each other without the user's knowledge. Although it is assumed above that background removal and density correction are performed as correction that is performed based on the setting level of blank sheet detection, the present invention is not limited to this. Specifically, the present invention can be applied to all limitations (choice) on correction processes that need to be correlated with each other during printing or outputting, with respect to processes of outputting a plurality of determination results for read image data.

### Fifth Embodiment

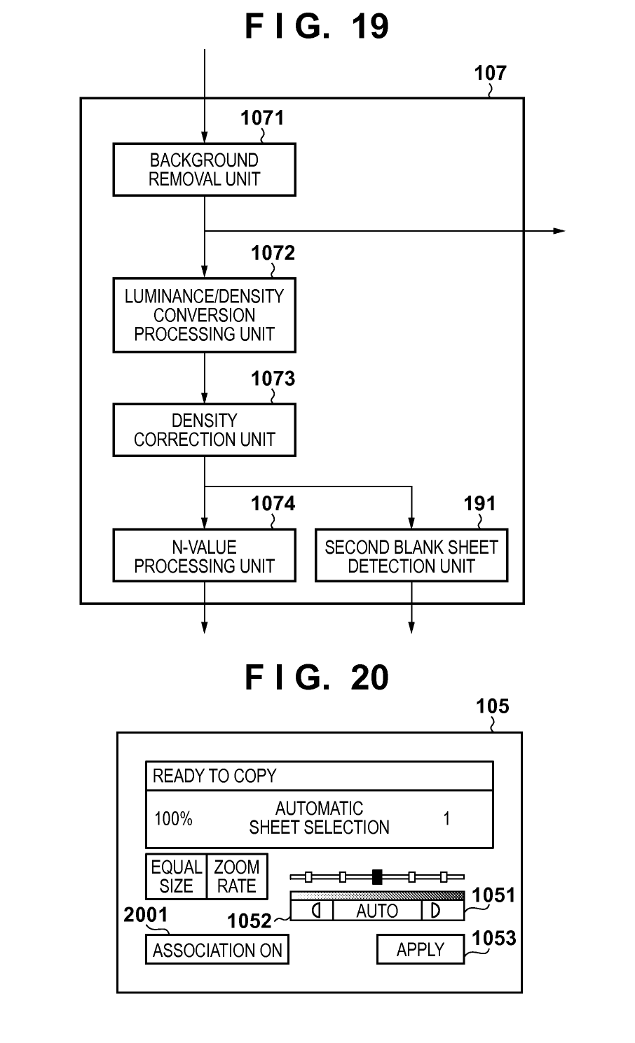

In the first to fourth embodiments, it is assumed that the blank sheet detection unit is provided in the image input unit 106. However, the present invention is not limited to these embodiments. FIG. 19 shows a case where a second blank sheet detection unit is provided in the image processing unit 107. Note that, in FIG. 19, the same components as those of the image processing unit 107 of the first to fourth embodiments are indicated by the same reference characters. As shown in FIG. 19, in this embodiment, a second blank sheet detection unit 191 is provided in the image processing unit 107. In this embodiment, output data of the density correction unit 1073 is input to the second blank sheet detection unit, which then performs blank sheet detection on the data. Also in this case, if the setting levels of the background removal unit 1071 and the density correction unit 1073 do not match the setting level of the second blank sheet detection unit 191, the result of blank sheet detection by the second blank sheet detection unit 191 does not match output image data of the image processing unit 107. For example, irrespective of background removal or density correction, image data that has been converted into image data representing a blank sheet may be directly output without being determined to represent a blank sheet. Therefore, in this embodiment, the setting level of the second blank sheet detection unit 191 provided in the image processing unit 107 is correlated with the setting levels of the background removal unit 1071 and the density correction unit 1073. As a result, image data that has been converted into image data representing a blank sheet is reliably determined to represent a blank sheet. Note that the correlation is achieved using a technique similar to that of the second or fourth embodiment. Specifically, when the same technique as that of the second embodiment is used, a limitation is put on the background removal setting level and the density correction setting level to be chosen that correspond to the setting level of the second blank sheet detection unit 191. When the same technique as that of the fourth embodiment is used, the range that can be chosen for background removal or the range that can be chosen for density correction, which corresponds to the setting level of the fourth blank sheet detection unit 191, is obtained, and based on this result, each region is divided into setting levels, which are then set in the operation unit 105.

Note that, as in the first to fourth embodiments, if the blank sheet detection unit 1064 is provided, and the setting levels of the blank sheet detection unit 1064 and the background removal unit 1071 are mutually limited, the outputting of image data input from the image input unit 106 that has been determined to represent a blank sheet can be reduced or prevented. However, blank sheet detection is not performed on image data input from a network etc., and therefore, that image data may be output even when it actually represents a blank sheet. Therefore, for example, as in the first embodiment, if the setting levels of the blank sheet detection unit and the background removal unit are controlled, the setting level of the blank sheet detection unit 1064 may be directly used as the setting level of the second blank sheet detection unit 191.

As described above, in this embodiment, when the blank sheet detection unit is provided in the image processing unit 107, the setting level of blank sheet detection and the setting level of background removal or the setting level of density correction are correlated with each other, resulting in an appropriate process.

### Sixth Embodiment

In the first to fifth embodiments, the setting levels of the blank sheet detection unit, the background removal processing unit, and the density correction processing unit that are provided in the image forming apparatus are associated with each other, whereby the apparatus can appropriately operate. However, the association operation may not always be automatically performed. A sixth embodiment for achieving this form will now be described. FIG. 20 is a diagram showing a feature of this embodiment. Note that, in FIG. 20, the same components as those described in the first to third embodiments are indicated by the same reference characters. This embodiment has a feature that a setting key 2001 is provided in the operation unit 105. The setting key 2001 is used to decide whether to automatically associate the setting level of the density correction processing unit with the setting levels of the blank sheet detection unit and the background removal processing unit in the image forming apparatus used in this embodiment. Specifically, the operations of the apparatus are changed by pressing down the setting key 2001 or based on an internal state of the apparatus held by pressing down the setting key 2001. By the automatic association operation, the setting levels of the blank sheet detection unit, the background removal processing unit, and the density correction processing unit described in the first to fifth embodiments are automatically adjusted. If the association operation is non-automatically performed, a limitation is not put on the setting level of blank sheet detection, background removal, or density correction, and the operation is performed based on the setting levels set in the operation unit 105 by the user. In this case, in the case of some combinations of the setting levels, the result of blank sheet detection and the output of the image forming apparatus used in this embodiment may mismatch. However, the operations are changed by a setting made by the user, and therefore, the chosen operation is assumed to be an operation of the apparatus that is intended by the user.

As described above, in the sixth embodiment, when the blank sheet detection unit is provided in the image processing unit 107, the association between the setting level of the blank sheet detection and the setting level of the background removal or the setting level of density correction can be changed according to the user's intention.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-149935, filed Jul. 18, 2013, which is hereby incorporated by reference herein in its entirety.

What is claimed is:

1. An image processing apparatus comprising:
a first setting unit that sets a first setting value used to determine whether or not an obtained original document is blank;
a second setting unit that sets a second setting value used to correct a component relating to a lightness of image data obtained by reading the original document;
a detection unit that determines whether or not an original document to be processed is blank, based on the first setting value set by the first setting unit; and
a processing unit that corrects the lightness of image data obtained by reading an original document that has been determined by the detection unit not to represent a blank sheet, based on the second setting value set by the second setting unit,
wherein
the setting range of the first or second setting value set by one of the first and second setting units is limited by the first or second setting value set by the other setting unit.

2. The image processing apparatus according to claim 1, wherein
the setting range of one of the first and second setting values is limited according to the other setting value so that the setting range is limited to a range within which the image data is not corrected by the processing unit.

3. The image processing apparatus according to claim 1, wherein
the first or second setting value set by one of the first and second setting units is limited by the first or second setting value set by the other setting unit to a range within which the image data corrected by the processing unit does not represent a blank sheet so that image data obtained by reading an original document that has been determined by the detection unit not to represent a blank sheet, based on the first setting value set by the first setting unit, is not converted into data that does not contain printed information, by image processing performed by the processing unit based on the second setting value set by the second setting unit.

4. The image processing apparatus according to claim 1, wherein
the image processing includes a background removal process.

5. The image processing apparatus according to claim 1, wherein
the image processing includes a density correction process.

6. The image processing apparatus according to claim 1, wherein
the first and second setting units receive respective setting values chosen by a user via a user interface displaying acceptable first and second setting values if the setting value falls within an acceptable range.

7. The image processing apparatus according to claim 6, wherein
the first and second setting units display, on the user interface, setting values obtained by sub-dividing the acceptable first and second setting values, respectively.

8. The image processing apparatus according to claim 1, wherein
the detection unit determines whether or not an original document to be processed is blank, using a plurality of first setting values that can be chosen,
the image processing apparatus further includes a storage unit for storing a result of the determination by the detection unit using each of the plurality of first setting values in association with the corresponding one of the plurality of first setting values, and
the result of the determination using the first setting value set by the first setting unit is processed by the processing unit.

9. An image processing apparatus comprising:
a setting unit that chooses, from a plurality of setting values, a setting value that is used in determining whether or not an obtained original document is blank;
a detection unit that determines whether or not an original document to be processed is blank for the plurality of setting values; and
a storage unit that stores results of the determination by the detection unit using the plurality of setting values in association with the corresponding one of the plurality of setting values, and the setting value chosen by the setting unit.

10. The image processing apparatus according to claim 9, wherein
the setting unit receives a setting value chosen by a user via a user interface displaying acceptable setting values if the setting value falls within an acceptable range.

11. A non-transitory computer readable medium in which a program is stored for causing a computer to function as:
a first setting unit that sets a first setting value used to determine whether or not an obtained original document is blank;
a second setting unit that sets a second setting value used to correct a component relating to a lightness of image data obtained by reading the original document;
a detection unit that determines whether or not an original document to be processed is blank, based on the first setting value set by the first setting unit; and
a processing unit that corrects the lightness of image data obtained by reading an original document that has been determined by the detection unit not to represent a blank sheet, based on the second setting value set by the second setting unit,
wherein
the setting range of the first or second setting value set by one of the first and second setting unit is limited by the first or second setting value set by the other setting unit.

12. A non-transitory computer readable medium in which a program is stored for causing a computer to function as:
a setting unit that chooses, from a plurality of setting values, a setting value that is used in determining whether or not an obtained original document is blank;
a detection unit that determines whether or not an original document to be processed is blank for the plurality of setting values; and
a storage unit that stores results of the determination by the detection unit using the plurality of setting values in association with the corresponding one of the plurality of setting values, and the setting value chosen by the setting unit.

13. An image processing method comprising:
setting a first setting value used to determine whether or not an obtained original document is blank;
setting a second setting value used to correct a component relating to a lightness of image data obtained by reading the original document;
determining whether or not an original document to be processed is blank, based on the first setting value set in the setting; and
correcting the lightness of image data obtained by reading an original document that has been determined in the detecting not to represent a blank sheet, based on the second setting value set in the setting,
wherein
the setting range of the first or second setting value set in one of the first and second setting is limited by the first or second setting value set in the other setting.

14. An image processing method comprising:
choosing, from a plurality of setting values, a setting value that is used in determining whether or not an obtained original document is blank;
determining whether or not an original document to be processed is blank for the plurality of setting values; and
storing results of the determination by the detection step using the plurality of setting values in association with the corresponding one of the plurality of setting values, and the setting value chosen in the setting.
